(19) United States
(12) Patent Application Publication
(10) Pub. No.: US 2012/0036429 A1
(43) Pub. Date: Feb. 9, 2012

(54) ELECTRONIC BOOK SYSTEM AND CONTENT SERVER

(75) Inventor: Yukinao Ajima, Tokyo (JP)

(73) Assignee: FOR-SIDE.COM CO., LTD., Tokyo (JP)

(21) Appl. No.: 13/125,339

(22) PCT Filed: Sep. 29, 2010
(86) PCT No.: PCT/JP2010/066984

§ 371 Date: Oct. 18, 2011

(30) Foreign Application Priority Data
Aug. 6, 2010 (JP) 2010-531348

(51) Int. Cl. G06F 17/21

(52) U.S. Cl. 715/259; 715/256

(57) ABSTRACT

An electronic book system, which provides a service for improving usability for users by sharing, acquiring, and analyzing text information and image information contained in an electronic book and various information items added to the electronic book, is provided. A typical aspect of the present invention includes a content server and a terminal including a viewer. The viewer includes comment input means that receives an input of a comment for transmission to the content server and freehand-memo input means that receives an input of a freehand memo for transmission to the content server; and the content server includes a comment processing unit that retains information about the comment in comment storing means, retains information about the freehand memo in freehand-memo storing means, causes the comment and the freehand memo to be displayed when a user browses the electronic book and, when another user browses the electronic book, causes the freehand memo to be displayed on a viewer of the another user.

### CROSS REFERENCE TO RELATED APPLICATIONS

This application is entitled to the benefit of and incorporates by reference essential subject matter disclosed in International Patent Application No. PCT/JP2010/066984 filed on Sep. 29, 2010, Japanese Patent Application Serial No. 2010-531348 filed on Aug. 6, 2010, and International Patent Application No. PCT/JP2010/57798 filed on May 7, 2010.

### TECHNICAL FIELD

The present invention relates to technologies regarding provision of electronic book service and, in particular, to an effective technology applicable to an electronic book system and content server using various information regarding an electronic book to provide various services including information sharing.

### BACKGROUND ART

In recent years, release and use of publications by means of electronic books have been rapidly spreading. The factors of this include the widespread use of a mobile terminal such as a mobile phone capable of browsing the content of the electronic book in addition to the PC (Personal Computer) and others. Furthermore, the use of dedicated terminals for browsing the electronic book using the technology of electronic paper and others has also been spreading recently.

In such a circumstance, various mechanisms for improving the user convenience in addition to allowing the user to simply browse content such as the electronic book and the newspaper article (hereinafter, simply referred to as “electronic book”) have been proposed. Examples thereof include a function by which the user can write a comment in an arbitrary place of the electronic book as if to put a tag. Furthermore, the utility form in which the written comments are mutually sent between users by using a communication function of the terminal has also been proposed.

As a technology relevant to those described above, for example, Japanese Patent Application Laid-Open Publication No. 2008-20961 discloses a technology in which when an instruction to close the display showing a part associated with a comment in an electronic book currently displayed on a display screen is received from a user, the comment is displayed on the screen, so that the comment is displayed after the end of the browse of the part associated with the comment and the comment can be displayed to the user browsing the content at the optimum timing.

Also, as an example using text information of a text of an electronic book, for example, Japanese Patent Application Laid-Open Publication No. 2006-53739 discloses a technology for an electronic book reading machine in which data of an electronic bookmark is read together with book data from an electronic book, a read start position is set based on the data of the electronic bookmark, the book data after the read start position is read and converted to a sound signal, and the signal is supplied to a speaker through an amplifier.

Furthermore, for example, Japanese Patent Application Laid-Open Publication No. 2006-331056 discloses a technology in which the control is carried out so that information relating to a keyword that is a character string specified by a user in the content of an electronic book is acquired from a server connected to the Internet, a dictionary database or stored information in a storage unit in accordance with a renewal deadline, whereby the appropriate information can be easily and quickly acquired from a wide range of information sources and information relating to the arbitrary character string in the electronic book can be acquired while maintaining the display of the electronic book.

Moreover, comments to be written on an electronic book is not limited to text information, and information of handwritten letters, images, etc. can be handled. For example, Japanese Patent Application Laid-Open Publication No. 2006-58917 discloses a technology related to an electronic book device which stores information inputted to a content such as an electronic book by handwriting using a touch panel and/or a pen as a multilayered content, creates each content as one layer when displaying, and displays selected layers overlapped after an image composition processing on the selected layers.

### DISCLOSURE OF THE INVENTION

As described above, various mechanisms for improving the user convenience have been proposed for the electronic book. In these mechanisms, however, the processing to the text information in the electronic book, the data retention and the management of the comments are mainly performed individually on the terminal's side, and the degree of the improvement in the user convenience is limited within the range of the utilization of the terminal by the user. Furthermore, the load on the terminal's side (processing load and capacity of storage area, etc.) is increased, and the influence is sometimes large when using a mobile terminal or the like.

When text information and image information contained in an electronic book and various kinds of information provided to the electronic book (also including comments provided by users, meta information regarding these, update history information, and others) can be collectively managed by a server, such information is shared among a plurality of users if possible; moreover, if contents (details) of the information can be acquired and analyzed, for example, various services for further improving usability for the users can be provided.

Further, if the user is not only allowed to add information, such as a comment (including handwritten characters, images, and others and meta data thereof) to the electronic book but also allowed to edit the contents of an electronic book itself by using and expanding the function of adding information for information sharing with other users, various services more attractive to the users can be provided.

Therefore, a preferred aim of the present invention is to provide an electronic book system and a content server capable of providing a service that improves usability for users by sharing, acquiring, and analyzing text information and image information contained in an electronic book and various information items provided to the electronic book. Also, another preferred aim of the present invention is to provide another electronic book system and content server capable of providing a service attractive to users by allowing the users to edit contents of an electronic book themselves and share them. The above and other preferred aims and novel characteristics of the present invention will be apparent from the description of the present specification and the accompanying drawings.

The typical ones of the inventions disclosed in the present application will be briefly described as follows.

An electronic book system according to a typical embodiment of the present invention is an electronic book system including a content server that retains and manages a content containing an electronic book and provides a service regarding browsing of the content including the electronic book via a network; and a terminal having one or more viewers to be connected to the content server via the network for browsing the electronic book, and has the following features.

That is, in the electronic book system, the viewer includes: comment input means that receives an input of a comment to be added to a desired position of the electronic book from a user and transmits information including the comment and the position to which the comment is added to the content server; and freehand memo input means that receives an input of a freehand memo to be added to a desired position of the electronic book from the user and transmits information including the freehand memo and the position to which the freehand memo is added to the content server.

Also, the content server includes a comment processing unit that retains information about the comment transmitted from the viewer in comment storing means in association with information about the user and the position to which the comment is added; retains information about the freehand memo transmitted from the viewer in freehand-memo storing means in association with the information about the user and the position to which the freehand memo is added in addition to storing information about an update history; when the user browses the electronic book using the viewer, acquires the information about the comment to a position in the electronic book being browsed added by each user from the comment storing means and causes the acquired information to be displayed on the viewer; also acquires the information about the freehand memo added to the position in the electronic book being browsed by the user from the freehand-memo storing means and causes the acquired information to be displayed on the viewer; and, when another user specified by the user browses the electronic book using the viewer, at a corresponding position in the electronic book, acquires the freehand memo retained in the freehand-memo storing means from the freehand-memo storing means and causes the acquired freehand memo to be displayed on the viewer of the another user.

Further, an electronic book system according to another typical embodiment of the present invention is an electronic book system including: a content server that retains and manages a content including an electronic book and provides a service regarding browsing of the content including the electronic book via a network; and a terminal having one or more viewers to be connected to the content server via the network for browsing the electronic book, and the electronic book system has the following features.

That is, in an electronic book system, the viewer includes editing means which receives an input of contents of editing an image on a desired page of the electronic book from a user owning the electronic book, transmits the contents of editing and information including a target page to be edited to the content server.

Also, the content server includes an image editing unit that retains information regarding the contents of editing transmitted from the viewer in edit information storing means in association with the information about the target page; retains information about an edited electronic book acquired by editing the electronic book by each user and information about each page regarding the edited electronic book in each of edited content storing means and page information storing means; and, when the user or another user allowed to browse the edited electronic book browses the target page of the edited electronic book with the viewer, causes the contents of editing the target page to be displayed, and the contents of editing are newly retained in the edit information storing means when the another user inputs new contents of editing to the target page of the edited electronic book.

The effects obtained by typical aspects of the present invention will be briefly described below.

According to a typical embodiment of the present invention, it is possible to provide a service for improving usability for users by sharing, acquiring, and analyzing text information and image information contained in an electronic book and various kinds of information provided to the electronic book. Also, according to a typical embodiment of the present invention, the contents of the electronic book themselves are edited by the users and are configured to be sharable, thereby providing a service attractive to the users.

### BRIEF DESCRIPTION OF THE DRAWINGS

FIG. 1 is a diagram illustrating a general outline of a configuration example of an electronic book system according to a first embodiment of the present invention;

FIG. 2 is a diagram illustrating an example of a data configuration of a content DB according to the first embodiment of the present invention;

FIG. 3 is a diagram illustrating an example of a data configuration of a member DB according to the first embodiment of the present invention;

FIG. 4 is a diagram illustrating an example of a data configuration of a comment DB according to the first embodiment of the present invention;

FIG. 5 is a diagram illustrating an example of a data configuration of a freehand memo DB according to the first embodiment of the present invention;

FIG. 6 is a diagram illustrating an example of a data configuration of a display advertisement DB according to the first embodiment of the present invention;

FIG. 7 is a diagram illustrating an example of a process flow upon viewing a comment added to a content according to the first embodiment of the present invention;

FIGS. 8A to 8D are diagrams illustrating examples of a screen upon displaying a content and a comment according to the first embodiment of the present invention;

FIG. 9 is a diagram illustrating an example of a process flow upon updating and adding a comment to a content according to the first embodiment of the present invention;

FIGS. 10A to 10D are diagrams illustrating examples of a screen upon adding a comment to a keyword of a content according to the first embodiment of the present invention;

FIG. 11 is a diagram illustrating an example of a process flow upon searching for a comment added to a content and browsing the comment according to the first embodiment of the present invention;

FIG. 12 is a diagram illustrating an example of a process flow upon adding a freehand memo to a page of a content according to the first embodiment of the present invention;

FIGS. 13A and 13B are diagrams illustrating examples of a screen at the time of adding a freehand memo to a page of a content according to the first embodiment of the present invention;

FIGS. 14A and 14B are diagrams illustrating examples of a screen upon displaying a freehand memo stored in a terminal according to the first embodiment of the present invention;

FIGS. 15A to 15D are diagrams illustrating examples of a screen upon displaying a freehand memo stored in a content server according to the first embodiment of the present invention;

FIGS. 16A to 16D are diagrams illustrating other examples of the screen upon displaying a freehand memo stored in the content server according to the first embodiment of the present invention;

FIG. 17 is a diagram illustrating an example of a process flow upon adding a comment to a content (an electronic article), such as a newspaper article or news, according to the first embodiment of the present invention;

FIGS. 18A to 18C are diagrams illustrating examples of a screen upon displaying a content of an electronic article and a comment according to the first embodiment of the present invention;

FIGS. 19A to 19D are diagrams illustrating examples of a screen upon adding a comment to a content of an electronic article according to the first embodiment of the present invention;

FIG. 20 is a diagram illustrating an example of a process flow upon searching a dictionary for a keyword of a content and translating and browsing text information of the content according to the first embodiment of the present invention;

FIGS. 21A and 21B are diagrams illustrating examples of a screen upon searching a dictionary for a keyword of a content according to the first embodiment of the present invention;

FIGS. 22A to 22C are diagrams illustrating examples of a screen upon translating and browsing text information of a content according to the first embodiment of the present invention;

FIGS. 23A and 23B are diagrams illustrating examples of a screen when reproducing audio information upon browsing a content according to the first embodiment of the present invention;

FIG. 24 is a diagram illustrating a general outline of an example of an image editing in an electronic book and sharing the same according to a second embodiment of the present invention;

FIG. 25 is a diagram illustrating a general outline of a configuration example of an edited content edited by a plurality of users according to the second embodiment of the present invention;

FIG. 26 is a diagram illustrating a general outline regarding a part of a configuration example of an electronic book system according to the second embodiment of the present invention;

FIG. 27 is a diagram illustrating an example of a data configuration of an edited content DB according to the second embodiment of the present invention;

FIG. 28 is a diagram illustrating an example of a data configuration of a page information DB according to the second embodiment of the present invention;

FIG. 29 is a diagram illustrating an example of a data configuration of a layer information DB according to the second embodiment of the present invention;

FIG. 30 is a diagram illustrating an example of a process flow upon editing a target page of a content according to the second embodiment of the present invention;

FIG. 31 is a diagram illustrating an example of a process flow upon editing a target page of a content according to the second embodiment of the present invention;

FIG. 32 is a diagram illustrating a general outline of an example of a display of contents of editing by each user when the edited content is shared according to the second embodiment of the present invention;

FIG. 33 is a diagram illustrating an example of a process flow upon editing a content by adding or deleting a page according to the second embodiment of the present invention;

FIG. 34 is a diagram illustrating an example of a process flow upon editing a content by adding or deleting a page according to the second embodiment of the present invention;

FIG. 35 is a diagram illustrating a general outline of an example of a display upon editing a content by adding a page according to the second embodiment of the present invention; and

FIG. 36 is a diagram illustrating a general outline of an example of a display upon editing a content by deleting a page according to the second embodiment of the present invention.

### BEST MODE FOR CARRYING OUT THE INVENTION

Hereinafter, embodiments of the present invention will be described in detail with reference to the accompanying drawings. Note that components having the same function are denoted by the same reference symbols throughout the drawings for describing the embodiment, and the repetitive description thereof will be omitted.

### First Embodiment

An electronic book system according to a first embodiment of the present invention is a system in which text information and image information contained in an electronic book and various information items attached to the electronic book (also including comments provided by users, meta information regarding these comments, update history information, and others) are collectively managed by a content server, and sharing of some of these information items, if possible, is performed among a plurality of users and contents of these information items are acquired and analyzed, for example, thereby providing various services for further improving usability for the users.

To explain more specifically, for example, a function is provided allowing a user to add a comment to an electronic book that is being browsed by the user and allowing the comment to be shared with another user. This comment can be not only added for each unit, such as page or frame of the electronic book, but also added to text (a keyword). Here, for example, a comment can be made on a specific user or can be posted to various kinds of so-called SNS (Social Networking Service) websites. Furthermore, a function is also provided in which an analysis is performed based on accumulation of information regarding a comment added by a user, thereby recommending a best-suited electronic book and displaying an advertisement to the user.

Still further, a function of adding a memo drawn freehand on an electronic book (hereinafter, it may be referred to as “freehand memo”) is added as a comment and the freehand memo is shared with another user. Still further, such functions are also provided that text information contained in the electronic book is used to perform, for example, a dictionary search for a keyword, an automatic translation on the text for display, and synchronous reproduction together with audio information.

[System Configuration]

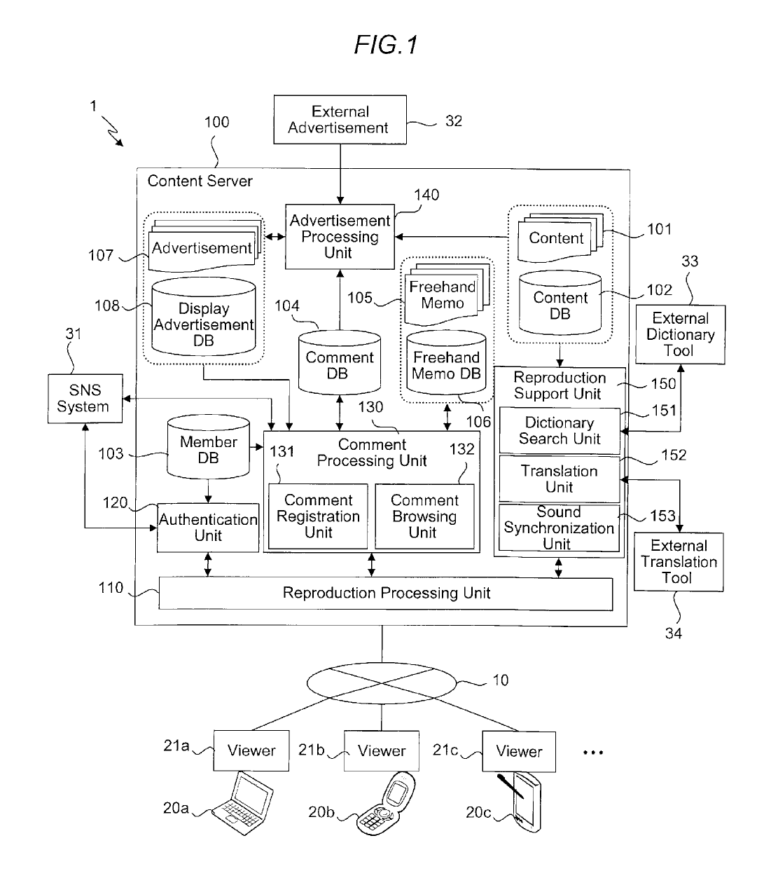

FIG. 1 is a diagram illustrating a general outline of a configuration example of an electronic book system according to the first embodiment of the present invention. An electronic book system 1 has a configuration in which various terminals 20 possessed by users are connected over a network 10, such as the Internet, to a content server 100 that manages contents including an electronic book, text information contained in the electronic book, and various information items provided to the electronic book (also including comments provided by users, meta information regarding these comments, update history information, and others) via viewers 21, which are software programs for viewing electronic books.

Here, an electronic book means a publication in which, for example, contents of a publication including a book such as a novel or a comic, news, an article, and others are published as a content of digital information, and is also browsable by using a display of an information processing device. The electronic book is not restricted to one sold by a publisher or the like and, for example, may be an electronic book made by a user himself or herself by converting an actual book or the like in an electronic format by scanning or the like. There are various file formats for electronic books. An electronic book in the present embodiment is assumed to be also able to retain text information regarding sentences in a content as data of the content. That is, the file format of the electronic book is not particularly restrictive as long as text information regarding a content can be included as an electronic book. This file of the electronic book is retained as a content 101 in the content server 100.

As the terminals 20, which are information processing devices for users to browse electronic books (contents 101), various devices can be used as long as they can execute their corresponding viewers 21. For example, not only a PC (a terminal 20a) but also a mobile telephone or the like (a terminal 20b), a terminal dedicated to electronic book reproduction (a terminal 20c) and others can be used. Also, it is assumed in the present embodiment that, in a method of browsing any of the contents 101 using the viewer 21, the content 101 retained on the content server 100 are browsed by streaming, browsing, and other, and, in another example, the content 101 can be browsed by being downloaded onto the terminal 20.

The content server 100 is composed of a computer system, and manages the contents 101, text information contained in the contents 101, and various information items provided to the electronic books (also including comments provided by users, meta information regarding these comments, update history information, and others) and provides a browsing service of the contents 101 by the viewer 21. For example, this content server 100 includes a reproduction processing unit 110, an authenticating unit 120, a comment processing unit 130, an advertisement processing unit 140, and a reproduction supporting unit 150, which are implemented by software programs, and also has databases or tables of a content DB 102, a member DB 103, a comment DB 104, a freehand memo DB 106, and a display advertisement DB 108.

The reproduction processing unit 110 has an interface that accepts a request regarding browsing of any of the contents 101 from the terminal 20 via the viewer 21, allowing browsing of the content 101 on the viewer 21 by a technology of, for example, general streaming or browsing. Note that various attribute information items regarding the content 101 for use in specifying and reproducing the content 101 is stored and managed in the content DB 102.

The authenticating unit 120 performs user authentication when the user of the terminal 20 browses the content 101, referring to the member DB 103 to determine whether the user is a member of an electronic book service provided from the electronic book system 1. Also, the authentication unit 120 may have a function of user authentication on an external system or tool in cooperation with the content server 100 including an SNS system 31 of any type.

The comment processing unit 130 has, for example, a comment registration unit 131 and a comment browsing unit 132 and, based on a request from a user via the viewer 21, performs processings, such as addition, updating, and browsing of a comment and a freehand memo on the content 101.

The comment registration unit 131 adds a text-base comment to the content 101 being browsed by the user and registers the comment in the comment DB 104, and adds a freehand memo 105 and registers its information in the freehand memo DB 106. Note that the freehand memo 105 retains image data of a memo drawn by the user on the viewer 21 as an image file in a format that can be transparent (such as gif format or png format). Also, the comment registration unit 131 registers information obtained by editing and updating on the existing freehand memo 105 by the user in the freehand memo DB 106.

The comment browsing unit 132 refers to the comment DB 104 and the freehand memo DB 106 to obtain a comment and the freehand memo 105 to be displayed on the viewer 21, and causes the viewer 21 to display them via the reproduction processing unit 110.

When the comment browsing unit 132 displays a comment on the viewer 21, the advertisement processing unit 140 displays information about an electronic book (a content 101) recommended for the user together with a so-called target advertisement. The content of the target advertisement may be retained in advance as an advertisement 107 by being regularly acquired from an external advertisement 32, which is an external system providing advertisement information, or by being registered by an administrator or the like of the electronic book system 1. Also, to specify the advertisement 107 to be displayed, information about which advertisement 107 is displayed at which position in each content 101 may be determined in advance and retained in the display advertisement DB 108 for reference.

The reproduction support unit 150 includes, for example, a dictionary search unit 151, a translation unit 151, and an audio synchronization unit 153 and provides various useful services when the user browses (reproduces) the content 101 on the viewer 21.

The dictionary search unit 151 uses, for example, an external dictionary tool 33, which is an external system providing a dictionary search service, to search for text information (a keyword) specified by the user in the content 101 to be browsed by the user by using the viewer 21, and displays a search result to on the viewer 21. Note that a dictionary tool may be arranged in the content server 100 for use.

The translation unit 152 uses, for example, an external translation tool 34 that is an external system providing a service of translation to another language, to translate text information in the content 101 to be browsed by the user by using the viewer 21, and displays a translation result on the viewer 21. Note that a translation tool may be arranged in the content server 100 for use.

When audio information is attached to the content 101 to be browsed by the user by using the viewer 21 or when the content 101 and audio information are managed in association with each other, the audio synchronization unit 153 synchronously reproduces the text information and the audio information of the content 101 for display on the viewer 21. Note that, as a technology of synchronously reproducing text information and audio information, any known technology for use in, for example, karaoke machines and language learning systems, can be used.

[Data Configuration]

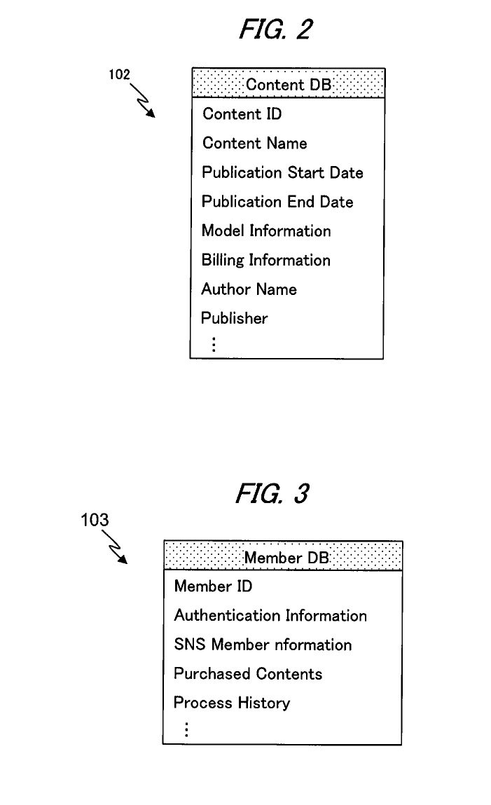

FIG. 2 is a diagram illustrating an example of a data configuration of the content DB 102. The content DB 102 is a table which manages various attribute information items and meta information regarding the electronic book (content 101), and includes items of, for example, content ID, content name, publication start date, publication end date, model information, billing information, author name, and publisher.

The content ID item retains ID information uniquely identifying each content 101. In the present embodiment, it is assumed, for example, that the file name of the content 101 (such as “A0001.tar”) is used as a content ID (the extension may be omitted from the file name). The content name item retains information about a title of the content 101. The publication start date item and the publication end date item retain information about a start time and an end time, respectively, of a period (a publication period) during which users are permitted to browse the target content 101.

The model information item retains information about a platform of the terminal 20 that can browse the target content 101 (for example, a model, OS (Operating System), or the like). That is, even when electronic books have the same contents, they may be achieved as a plurality of contents 101 depending on the platforms of the terminals 20 capable of browsing. The billing information item retains information, such as a billing method and price for browsing the target content 101. The author name item and the publisher item retain information about an author and a publisher, respectively, of the target content 101. Note that each of these items mentioned above regarding the content DB 102 is merely an example and, as a matter of course, relevant information may be managed with another data configuration.

FIG. 3 is a diagram illustrating an example of a data configuration of the member DB 103. The member DB 103 is a table that manages account information for users, who are members of an electronic book service provided from the electronic book system 1, and includes items of, for example, member ID, authentication information, SNS member information, purchased contents, and processing history.

The member ID item retains ID information uniquely identifying each user as a member. That is, the member ID item retains information about a user ID when the user accesses the content server 100 from the terminal 20 for login. The authentication information item retains information for user authentication (for example, a password) when the target member (user) logs in to the content server 100. The SNS member information item retains account information (information about user ID/password or the like that allows login to the SNS system 31) the target user owns in one or more other SNS systems 31.

The purchased contents item retains information specifying browsable contents 101 purchased by the target user. For example, the purchased contents item retains values of content IDs of one or more browsable contents 101. When the browsable contents 101 are contents that can be shared with another user (for example, when a content 101 purchased by a user is shared among grouped users and can be freely viewed), information about a member ID specifying a sharing user(s) may be retained together. The processing history item retains, in a time series, information regarding history of various processings, such as browsing of the content 101 and addition of a comment by the target user accessing the content server 100. Note that each of these items mentioned above related to the member DB 103 is merely an example and, as a matter of course, relevant information may be managed with another data configuration.

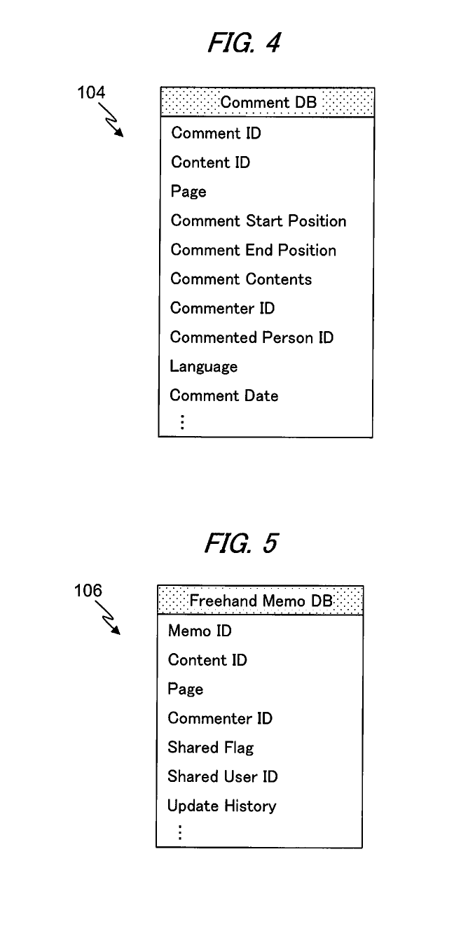

FIG. 4 is a diagram illustrating an example of a data configuration of the comment DB 104. The comment DB 104 is a table which retains information regarding a text-base comment added by the user to the content 101, and includes items of, for example, comment ID, content ID, page, comment start position, comment end position, comment contents, commenter ID, commented person ID, language, comment date.

The comment ID item retains ID information uniquely identifying a target comment. This value may be a value unique over the entire electronic book system 1, or may be a value unique in the content 101. The content ID item retains information specifying the content 101 to which the target comment is added.

Information about the page retains information about a page to which the target comment is added in the target content 101, information about the comment start position retains information about a start position in the target content 101, and information about the comment end position retains information about an end position in the target content 101. When a value is not specified for these items, the target comment can be handled as being added to the entire target content 101. Also, when values are not specified for the comment start position item and the comment end position item, the target comment can be handled as being added to the entire target page. The comment start position and comment end position items can be specified with, for example, the number of bytes from the head in text information of the content 101 or the target page.

The comment content item retains text information, which is a main body of the target comment. The commenter ID item retains information about a member ID specifying a user who added the target comment. The commented person's ID retains information about a member ID specifying a target user when the target comment is a comment to a specific user. Note that information about a plurality of users can be retained as target users, and information about a group composed of a plurality of users can be retained. The language item retains information indicative of a language of the target comment. The comment date item retains information about a timestamp at the time of addition of the target comment. Note that each of these items above regarding the comment DB 104 is merely an example and, as a matter of course, relevant information may be managed with another data configuration.

FIG. 5 is a diagram illustrating an example of a data configuration of the freehand memo DB 106. The freehand memo DB 106 is a table which retains meta information regarding the freehand memo 105 added by the user to the content 101, and has items including, for example, memo ID, content ID, page, commenter ID, share flag, shared person's ID, and update history.

The memo ID item retains ID information uniquely identifying each freehand memo 105. In the present embodiment, it is assumed, for example, that the file name of the freehand memo 105 (such as “B0001_U0002.gif”) is used as a memo ID (the extension may be omitted from the file name). The content ID item and the page item retain information specifying the content 101 and page, respectively to which the target freehand memo 105 is added. The commenter ID item retains information about the member ID specifying the user who added the target freehand memo 105.

The share flag item retains information about a flag indicating, when the content 101 added with the target freehand memo 105 can be shared with another user, whether to share the target freehand memo 105 with the other user. Also, the shared person's ID item retains information about a member ID specifying a target user who shares the target freehand memo 105. Note that information about a plurality of users can be retained as target users, or information about a group composed of a plurality of users can be retained. The update history item retains information about update history for the target freehand memo 105 (for example, update date and information about update users). Note that each of these items above regarding the freehand memo DB 106 is merely an example and, as a matter of course, relevant information may be managed with another data configuration.

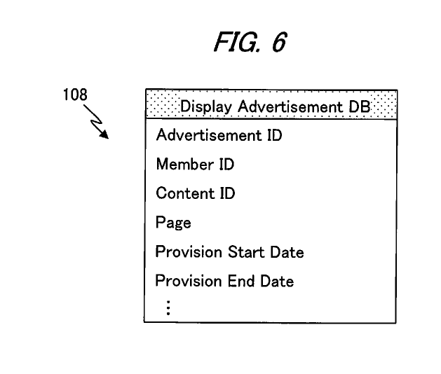

FIG. 6 is a diagram illustrating an example of a data configuration of the display advertisement DB 108. The display advertisement DB 108 is a table which retains information about which advertisement 107 is to be displayed at which position when the user browses (a comment added to) the content 101 by using the viewer 21, and has items including, for example, advertisement ID, member ID, content ID, page, provision start date, and provision end date.

The advertisement ID item retains ID information specifying the target advertisement 107 to be displayed on the viewer 21. In the present embodiment, it is assumed, for example, that the file name of the advertisement 107 is used as an advertisement ID. The member ID item retains information about a member ID specifying a target user for display of the target advertisement 107. The content ID and page items retain information specifying the content 101 and page, respectively, for display of the target advertisement 107. The provision start date and provision end date items retain information about the start and end dates, respectively, of a period during which the target advertisement 107 is displayed. Note that each of these items mentioned above regarding the display advertisement DB 108 is merely an example and, as a matter of course, relevant information may be managed with another data configuration.

[Process Contents—Basic Functions]

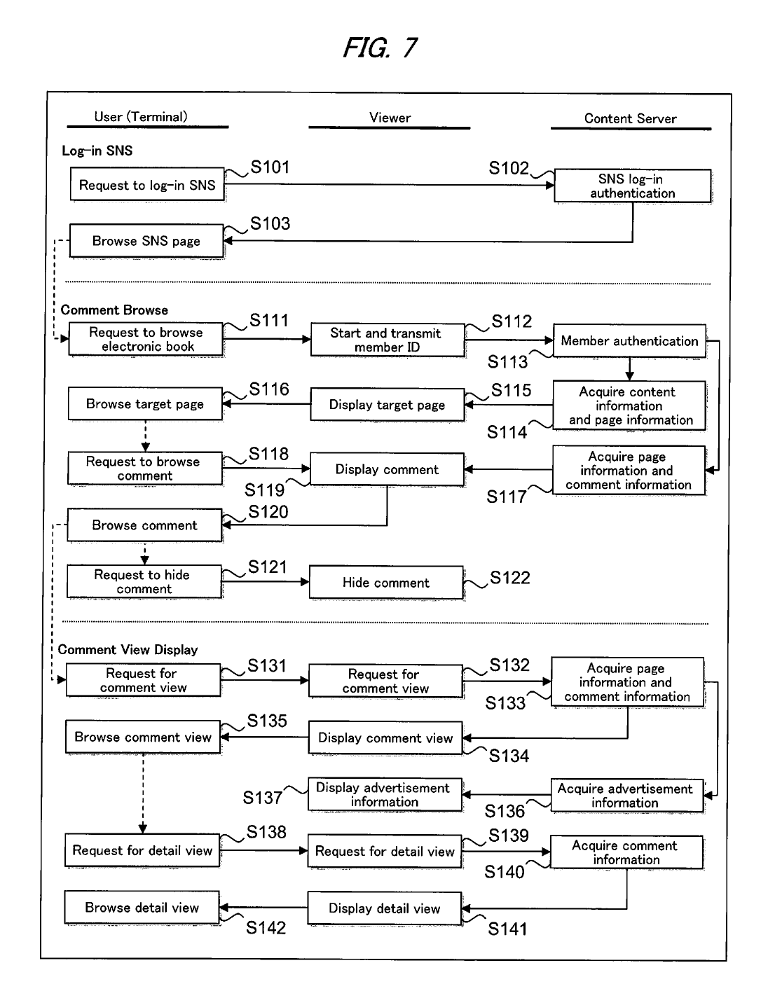

In the following, contents of process for achieving basic functions in the electronic book system 1 of the present embodiment will be described. FIG. 7 is a diagram illustrating an example of a process flow upon browsing a comment added to the content 101. Prior to viewing the comment, the user may make a login request to an SNS site (the SNS system 31) as required on the terminal 20 (S101).

In the content server 100 receiving a login request including the member ID from the terminal 20, account information for that user in the SNS system 31 is acquired from the member DB 103 to perform login authentication for the SNS system 31, and a top page or the like of the user in the SNS system 31 is displayed on the terminal 20 (S103). From this function of posting and browsing a comment in the SNS system 31, the user may be guided to a service of posting and browsing the electronic book (the content 101) and comments by the electronic book system 1. Note that, although login authentication for the SNS system is first performed in the example of FIG. 7, login authentication for the SNS system 31 can be performed at any timing during browsing of the content 101.

The user using the comment browsing service of the electronic book system 1 uses the terminal 20 to make a request for viewing the electronic book (content 1) through selection from a menu or the like (S111). A request for viewing the content 101 can be made through a guide from another site, such as the SNS system 31, as described above. Here, in the terminal 20, by referring to information retained in the terminal 20 or information retained in the member DB 103 of the content server 100, information about contents 101 which are allowed to be browsed by the user may be presented and, based on this information, the content 101 to be browsed may be selected by the user.

Upon the browsing request from the user, the terminal 20 starts the viewer 21 and, upon receiving an input of the member ID and authentication information from the user, transmits information about member ID and authentication information and the content 101 to be browsed to the content server 100 (S112). In the content server 100, by referring to the member DB 103 by the authenticating unit 120, authentication to determine whether the user is a member (user authentication) is performed (S113).

Then, with the reproduction processing unit 110 referring to the content DB 102, the member DB 103, and others, it is determined whether the user is allowed to browse the target content 101. If the user is allowed to browse, information about contents of the content 101 and a page thereof to be displayed is acquired for transmission to the viewer 21 (S114). With the target page being displayed on the viewer 21 based on the transmitted contents (S115), the user can browse the page of the target content 101 (S116).

Also, in the content server 100, for example, as a parallel process for the step S114, information about a comment added to each page of the target content 101 is acquired from the comment DB 104 and transmitted to the viewer 21 (S117). When the user browsing the page of the content 101 makes a request for browsing a comment (S118), a comment corresponding to the target page is displayed on the viewer 21 (S119), thereby allowing the user to browse the comment added to the target page etc. (S120). Also, the user can make a request for hiding a comment (S121). At this time, the viewer 21 hides the relevant comment (S122).

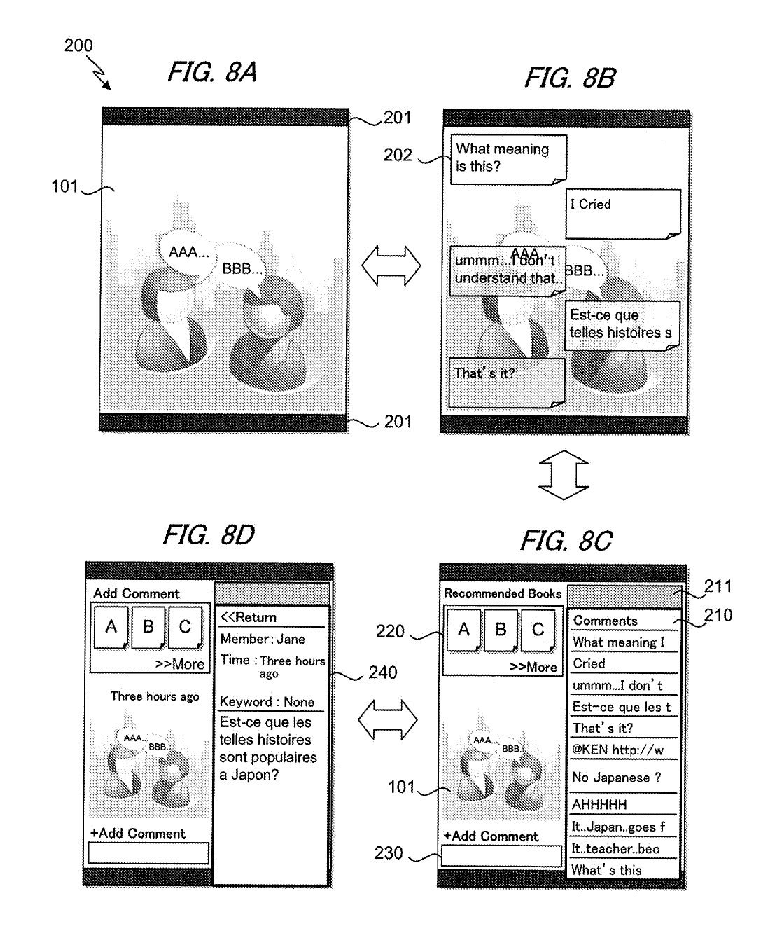

FIG. 8 is a diagram illustrating examples of a screen when displaying the content 101 and a comment on the viewer 21. FIG. 8A illustrates an example when a page of the content 101 is displayed on a display 200 in the viewer 21. Here, in the present embodiment, an example is shown in which the content 101 is displayed on a portable terminal having a touch panel, such as a so-called smart phone. On the screen, for example, a menu area 201 is provided where various menus, buttons, and others for the user to operate the viewer 21 are displayed at upper and lower positions on the screen.

For example, upon an instruction from the user via the menu area 201, the viewer 21 displays comments added to the target page, as illustrated in FIG. 8B. Here, when displaying comments, for example, a comment layer that can be displayed in a transparent format is displayed on the target page, and comments added by each user are displayed in a plurality of comment display areas 202 in the comment layer. Also, upon an instruction from the user via the menu area 201, the comment layer of the target page is not displayed, thereby hiding the comments as illustrated in the display in FIG. 8A.

Referring back to FIG. 7, with the comments added to the target page being displayed on the screen as illustrated in FIG. 8B and viewed, the user can make a request for browsing a comment view in which various information regarding each comment added to the target page can be referred to (S131). The viewer 21 transmits a request for displaying the comment view to the content server 100 (S132). In the content server 100, the comment browsing unit 132 acquires from the comment DB 104 information about each comment added to the target page and transmits the acquired information to the viewer 21 (S133). With the comment view being displayed on the viewer 21 based on the transmitted contents (S134), the user can browse the comment view (S135).

Note that, in the content server 100, when the comment browsing unit 132 acquires information about each comment and transmits the acquired information to the viewer 21 at the step S133, the advertisement processing 140 further extracts information about another electronic book (content 101) to be recommended for the user and information about a target advertisement (advertisement 107) and transmits the extracted information to the viewer 21 (S136). Based on the transmitted contents, the viewer 21 displays the recommended electronic book and the target advertisement on the comment view (S137).

At the step S136, for example, the advertisement processing unit 140 makes an analysis by a language processing based on the contents of the comments, the target content 101, the page, text information, such as a keyword, displayed by the comment browsing unit 132 on the viewer 21, and extracts one or more keywords. By matching these keywords and keywords provided to the content 101 and the advertisement 107, it is possible to determine which content 101 is to be recommend at which page of the content 101 and which advertisement is to be displayed.

Note that, in addition to matching with the use of text information, information about attributes and processing history (activity history) of the user retained in the member DB 103 and others may be taken as conditions. Also, when no relevant content 101 or advertisement 107 is present, a determination is made according to a predetermined rule, such as most recent first. Furthermore, these information items can be created in advance by a regular processing in the advertisement processing unit 140 or registration by the administrator or the like of the electronic book system 1 and retained in the display advertisement DB 108.

The user can make a request for browsing a comment detail view in which contents of any comment selected from the comment view can be referred to (S138). The viewer 21 transmits information about the selected comment, such as the comment ID, and also a request for displaying a comment detail view to the content server 100 (S139). In the content server 100, the comment browsing unit 132 acquires detailed information about the target comment from the comment DB 104 and transmits the acquired information to the viewer 21 (S140). With the comment detail view being displayed on the viewer 21 based on the transmitted contents (S141), the user can browse the comment detail view (S142).

FIG. 8C is a diagram illustrating an example of the screen when the comment view is displayed. In the example of FIG. 8C, the content 101 is displayed as being reduced, and a list of comments added from a plurality of users to the target page or the like is displayed in a time series in a comment list area 210. This information may be automatically refreshed on a regular basis to acquire new information or may be manually refreshed. Note that, for example, the comment list area 210 has a menu area 211 on an upper portion, allowing various operations by the user on the comments (for example, keyword search). Also, for example, in an advertisement display area 220, information about recommended books is displayed as contents 101 to be recommended for the user. Furthermore, a comment input area 230 is provided to allow a comment to be input and added.

For example, upon an instruction from the user via the menu area 211, the viewer 21 displays detailed contents of the comment selected by the user with a comment detail view illustrated in FIG. 8D. In the comment detail view, for example, in a comment display area 240, contents of each item retained in the comment DB 104 regarding the target comment are displayed. Also, an operation of replying a comment to the target comment, an operation of adding a new comment by quoting the target comment, and other operations can be performed. Note that information regarding a reply and quoting in an added comment can be directly embedded in the text information about the comment.

In the example described above, while the example has been described in which the terminal 20 is taken as a portable terminal to display the content 101 and the comment, in another case, it can be assumed that the same user browses the same purchased content 101 by using another terminal 20, such as a PC. In this case, depending on the platform of the terminal 20, the file format may be different and, in the content server 100, an individual content 101 may be provided for each platform of the terminal 20.

In the present embodiment, the comment is separated from the content 101 and is retained in the comment DB 104 as text information in the content server 100. Therefore, even in the case described above, it is assumed that the difference based on the platform of the terminal 20 is absorbed by the corresponding viewer 21, and a comment added in the viewer 21 of a terminal 20 can be displayed on the viewer 21 of the terminal 20 of another platform in the same manner.

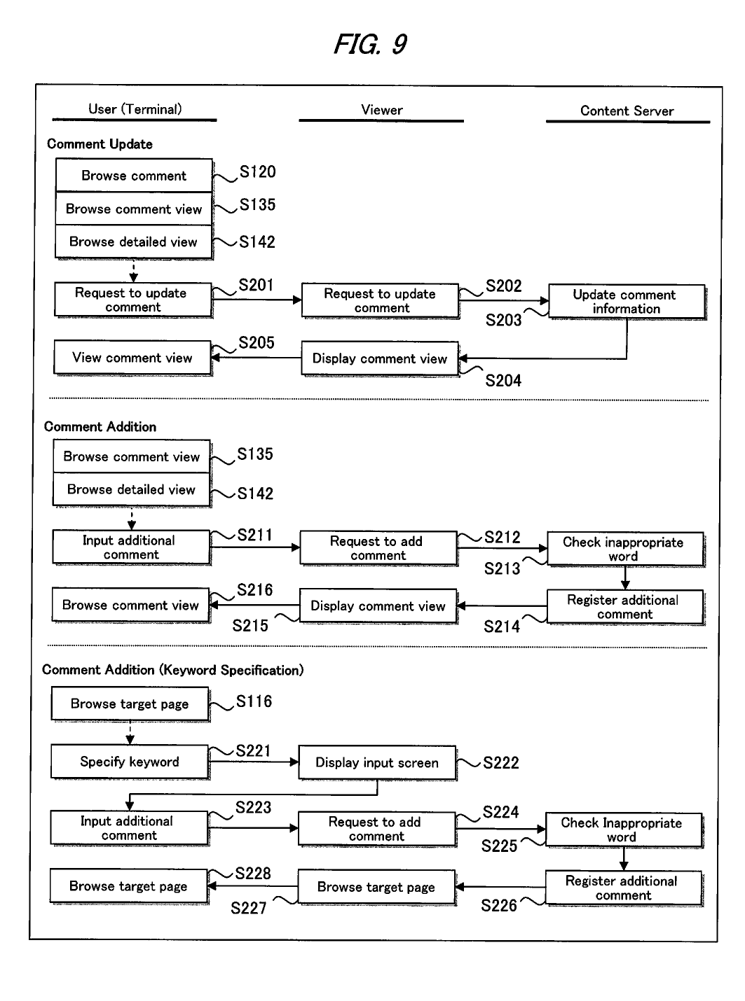

FIG. 9 is a diagram illustrating an example of a process flow upon updating and adding a comment to the content 101. For example, with comments added to the target page being viewed on the screen as illustrated in FIGS. 8B to 8D, the user can select a comment added by him or her to input contents of update of the comment and makes a request for updating the comment (S201). The viewer 21 transmits the updating request containing the comment ID and update contents of the target comment to the content server 100 (S202). In the content server 100, the comment registration unit 131 updates contents of the target comment in the comment DB 104, acquires information about the comment after updating, and transmits the acquired information to the viewer 21 (S203). With the comment view and others being viewed on the viewer 21 based on the transmitted contents (S204), the user can browse the comment view and others including the updated comment (S205).

Also, for example, with the comment added to the target page being browsed on the screen as illustrated in FIGS. 8C and 8D, the user can input a comment in the comment input area 230 to add a comment on the target page (S211). The viewer 21 transmits to the content server 100 a request for adding a comment including contents of the added comment and information about the target content 101 and the page (S212).

In the content server 100, the comment registration unit 131 checks to see whether any NG word, which is an inappropriate word, is included in wordings of the comment (S213). When no NG word is included, a comment ID is provided and the added comment is registered in the comment DB 104; and then, information about the comment after registration is acquired and transmitted to the viewer 21 (S214). With the comment view and others being displayed on the viewer 21 based on the transmitted contents (S215), the user can browse the comment view and others including the added comment (S216).

Note that, when a comment is added, a comment can be added to a specific user. For example, by inserting wordings of “@ [specific user's member ID]” at the head of the comment, the comment to the specific user can be made. Note that the technique of specifying a specific user is not restricted to the above-described one, but another technique can be used as long as information about a specific user (a plurality of users or a group may be possible) can be retained in association with the comment.

Also, for example, with the target page being browsed on the screen as illustrated in FIG. 8A, to add a comment to any keyword in the text information in the page, the user selects a range to be specified as a keyword in the text information (S221). The viewer 21 receiving information about the specified range of the keyword displays a screen for comment input (S222). The user inputs a comment on the screen for comment input, thereby adding a comment on the target keyword (S223).

The viewer 21 transmits to the content server 100 a request for adding a comment including contents of the added comment, the target content 101, and information about the range specified as a keyword (S224). In the content server 100, the comment registration unit 131 checks to see whether no NG word is included in the wordings of the comment (S225). Then, the comment ID is provided and the added comment is registered in the comment DB 104, and then, information about the comment after registration is acquired and transmitted to the viewer 21 (S226). With the target page being displayed on the viewer 21 based on the transmitted contents (S227), the user can browse the page including the information about the added comment (S228).

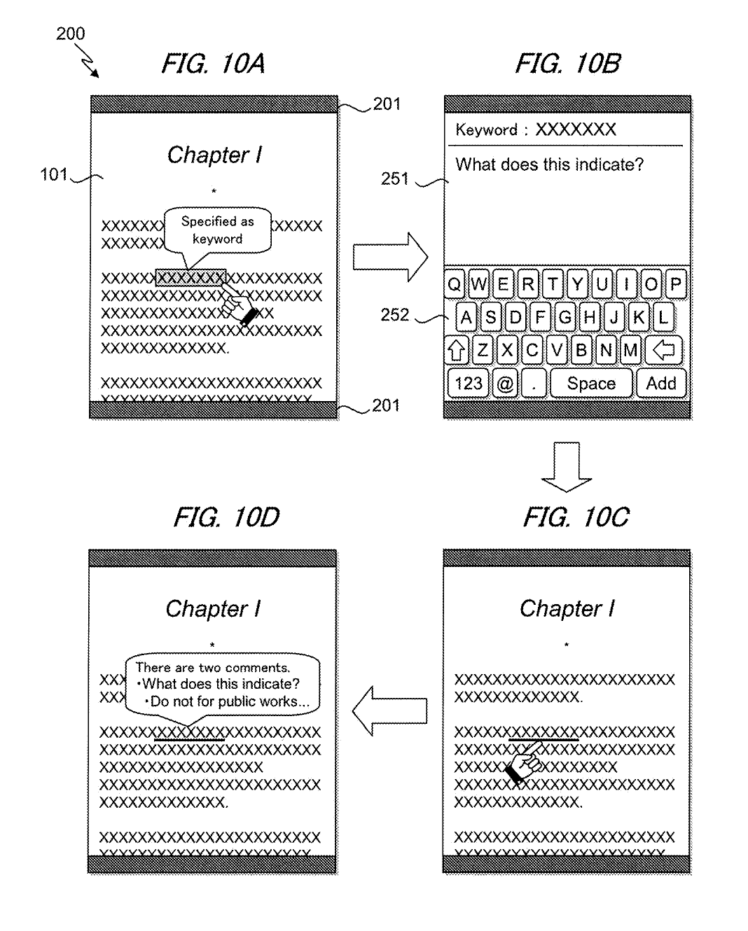

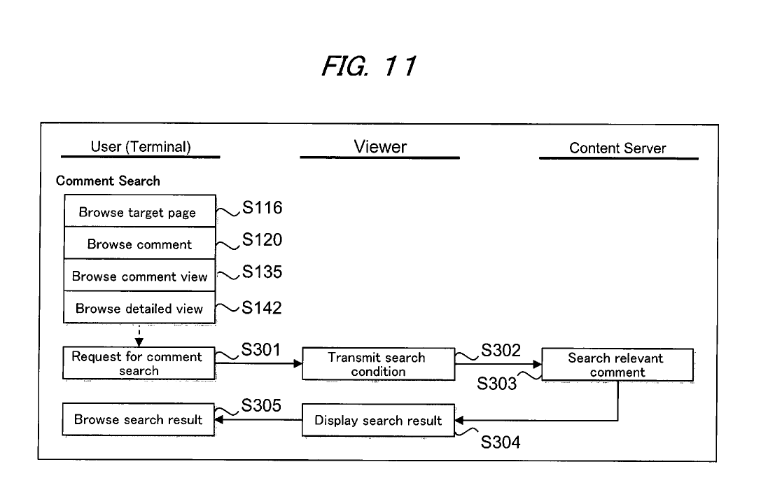

FIGS. 10A to 10D are diagrams illustrating examples of a screen upon adding a comment to a keyword of the content 101 on the viewer 21. FIG. 10A is a diagram illustrating an example of the screen when a range of a target keyword to which a comment is to be added is specified at the step S221 in FIG. 9. As illustrated in the drawing, a range of a word to be specified as a keyword is selected with a procedure of, for example, range specification in text editing. With an interface, such as clicking a “Specified as keyword” popup, a word included in a specified range is selected as a keyword.

A keyword is specified not as a word but with the number of bytes from the head of the content 101 or the page. In this manner, when the same word or idiom is present in the content 101, it is possible to prevent the situation where it is unclear to which word or idiom the comment is added. Also, for example, even when a plurality of types of idioms including a word at the same position are specified as keywords, they can be individually specified.

Note that, to specify a range of a keyword, for example, an instruction may be provided for specifying a keyword from the menu area 201 during viewing of the page and adding a comment and specification may be performed after the procedure goes to a mode of specifying a range of a keyword, or a range specification for text information may be performed during browsing of the page and an instruction may be provided for adding a comment to that range from the menu area 201, a popup, or the like.

FIG. 10B is a diagram illustrating an example of the screen where a comment is input for the selected keyword at step S223 of FIG. 9. For example, to a comment input area 251, a comment can be input by using a software keyboard 252 or the like.

FIG. 10C is a diagram illustrating an example of the screen when the page of the content 101 with a comment added to the keyword is displayed. For example, an underline may be provided for display to a portion of the keyword added with a comment. Note that, when a plurality of types of idioms including a word at the same position are specified as keywords, they can be distinguished by, for example, being doubly underlined for display. With this underlined portion being selected by clicking or the like, for example, as illustrated in FIG. 10D, a list of comments added to the corresponding keyword is displayed as a popup or the like. From this popup, based on an instruction from the user, a transition can further be made to a comment view or a comment detail view illustrated in, for example, FIGS. 8C and 8D.

FIG. 11 is a diagram illustrating an example of a process flow upon searching for a comment added to the content 101 for browsing. For example, with the target page or the comment added to the target page being browsed on the screen as illustrated in FIGS. 8A to 8D, the user can make a request for specifying a search condition and searching for a keyword of the comment (S301). The viewer 21 transmits information about the content 101 and the page and information including the specified search condition to the content server 100 (S302). In the content server 100, the comment browsing unit 132 acquires, from the comment DB 104, a comment including the keyword specified as a search condition among the comments added to the target page and transmits the obtained comment to the viewer 21 (S303). With the transmitted information about the search result being displayed on the viewer 21 (S304), the user can view the search result to narrow the comments down (S305).

Here, as described above, in the present embodiment, by inserting wordings of, for example, “@ [specific user's member ID]”, at the head of the comment, the comment to the specific user can be made. Therefore, for example, by automatically or manually specifying “@ [my member ID]” as a search condition, a comment added for the user himself or herself can be extracted. Furthermore, information about a timestamp of the previous search is retained in the terminal 20 and is transmitted together with the search condition and others transmitted from the viewer 21 to the content server 100. In this manner, only most recent comments added after the previous search can be extracted as the search result.

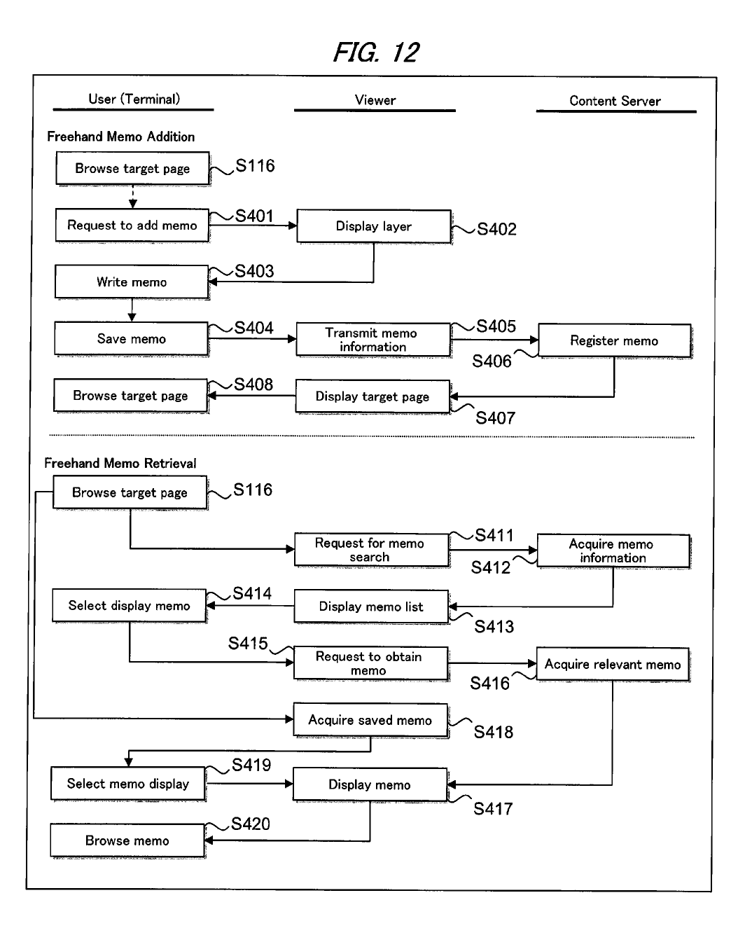

FIG. 12 is a diagram illustrating an example of a process flow upon adding a freehand memo to a page of the content 101. For example, with the target page being browsed on the screen as illustrated in FIG. 8A, the user can make a request for adding a freehand memo to the target page (S401). Here, the viewer 21 displays on the target page a new layer for drawing a freehand memo that can be displayed in a transparent format (S402). To this layer, the user writes a memo through handwriting input (S403) and stores the same (S404).

As a storage destination of the freehand memo, (a storage device of) the terminal 20 or the content server 100 can be selected. When the freehand memo is stored in the terminal 20, the freehand memo can be browsed only when the terminal 20 is used to browse the content 101. On the other hand, when the freehand memo is stored in the content server 100, the freehand memo can be shared with a terminal 20 of another platform and/or other specified users. It is assumed that sharing with other users includes, as is the case of the comment by text, in addition to sharing among users purchasing the target content 101 and allowed to browse it, sharing of the target content 101 itself (the same content 101 is shared among a plurality of users for browsing).

When the freehand memo is retained in the content server 100, the viewer 21 transmits information about the target page of the content 101 and contents of the freehand memo (image file data displayed as a layer) (S405). Whether the freehand memo is to be shared with other users nor not and information about target users in the case of sharing are also transmitted. In the content server 100, the comment registration unit 131 retains the image file data of the freehand memo as a freehand memo 105, registers the contents in the freehand memo DB 106, acquires information about the freehand memo 105 after registration, and transmits the acquired information to the viewer 21 (S406). With the target page being displayed on the viewer 21 based on the transmitted contents (S407), the user can browse the page including the added freehand memo 105 (S408).

Note that, in the content server 100, a file name of the freehand memo 105 is renamed as, for example, “content ID+member ID” (such as “B0001_U0002.gif”), thereby associating the content 101 and the user and the freehand memo 105 with each other.

Also, for example, when the target page is browsed on the screen as illustrated in FIG. 8A, the user can retrieve the freehand memo 105 added to the target page. When the user browses the target page, the viewer 21 makes a request for searching for the freehand memo 105 stored in the content server 100 or shared with another user (S411). In the content server 100, the comment browsing unit 132 refers to the freehand memo DB 106 to obtain the freehand memos 105 stored by the target user or the information about the freehand memos 105 shared with another user for transmission to the viewer 21 (S412).

The viewer 21 displays information about a list of the transmitted freehand memos 105 (S412). The user can select, from the list of the freehand memos 105, one or more freehand memos 105 to be displayed (S414). The viewer 21 transmits a request for acquiring data including information specifying the selected freehand memo 105 to the content server 100 (S415). In the content server 100, the comment browsing unit 132 refers to the freehand memo DB 106 to acquire data of the corresponding freehand memo 105, and transmits the acquired data to the viewer 21 (S416). With the target page and the layer of the freehand memo 105 being displayed on the viewer 21 based on the transmitted contents (S417), the user can view the page containing the selected freehand memo 105 (S420).

Meanwhile, when the user browses the target page, the viewer 21 acquires information about the list of the freehand memos stored in the terminal 20 for display (S418). The user can select, from the list of the freehand memos, one or more freehand memos to be displayed (S419). With the target page and the layer of the selected freehand memo being displayed on the viewer 21 (S417), the user can browse the page including the selected freehand memo 105 (S420). Note that the processings from the steps S411 to S413 and the processing at the step S418 may be performed in parallel, and a list of the freehand memos 105 stored in the content server 100 and a list of the freehand memos stored in the terminal 20 may be displayed together to let the user select.

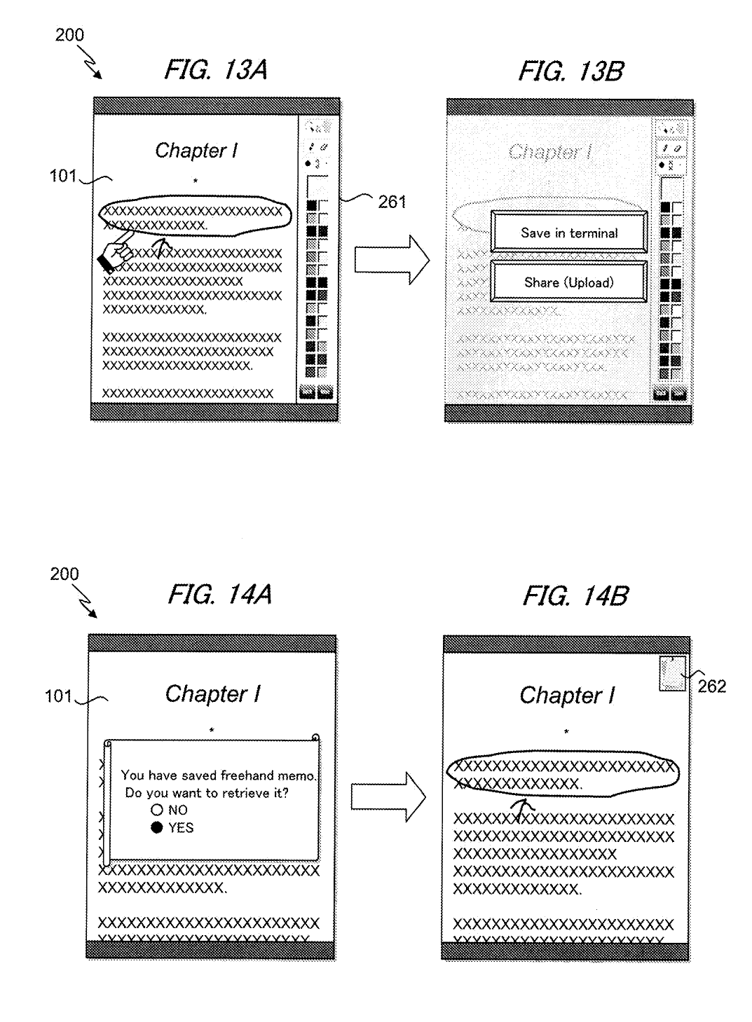

FIG. 13 is a diagram illustrating examples of a screen at the time of adding a freehand memo to a page of the content 101 on the viewer 21. When displaying a layer in which a freehand memo is written at the step S402 of FIG. 12, the viewer 21 also displays a drawing tool 261, as illustrated in FIG. 13A, for example. By using this drawing tool 261 or the like, as illustrated in the drawing, the user freely writes a memo through handwriting.

Here, when the user stores a freehand memo at the step S404 of FIG. 12, the viewer 21 displays a screen for specifying a storage destination as illustrated in FIG. 13B, letting the user select either one of storing in the terminal 20 and uploading to the content server 100 for storage. When storing in the content server 100 is selected, whether sharing with another user is permitted can further be determined, and, when such sharing is determined to be permitted, a user for sharing can be specified. Note that, when the target content 101 itself is shared with another user, it is assumed that specification regarding sharing as described above can be made only by a user purchasing the content 101.

FIGS. 14A and 14B are diagrams illustrating examples of a screen upon displaying a freehand memo stored in the terminal 20 on the viewer 21. When a freehand memo stored in the terminal 20 is present at the step S418 of FIG. 12, the viewer 21 displays a confirmation screen as illustrated in FIG. 14A, letting the user select whether to retrieve the freehand memo for display. When a plurality of freehand memos are stored, a selection screen may be displayed.

When the user selects retrieving the freehand memo for display, the viewer 21 retrieves a file of the target freehand memo from the terminal 20 at the step S417 of FIG. 12 and displays it as a layer in a transparent format on the content 101 as illustrated in FIG. 14B. Note that the displayed freehand memo may be able to be browsed only when required by switching between display and hide for each pressing of a display switch button 262 in the drawing.

Note that, from the display screen of the freehand memo as illustrated in FIG. 14B, the viewer 21 further displays a screen for writing a freehand memo as illustrated in FIG. 13A based on an instruction from the user. In this manner, the user can update the contents of the existing freehand memo.

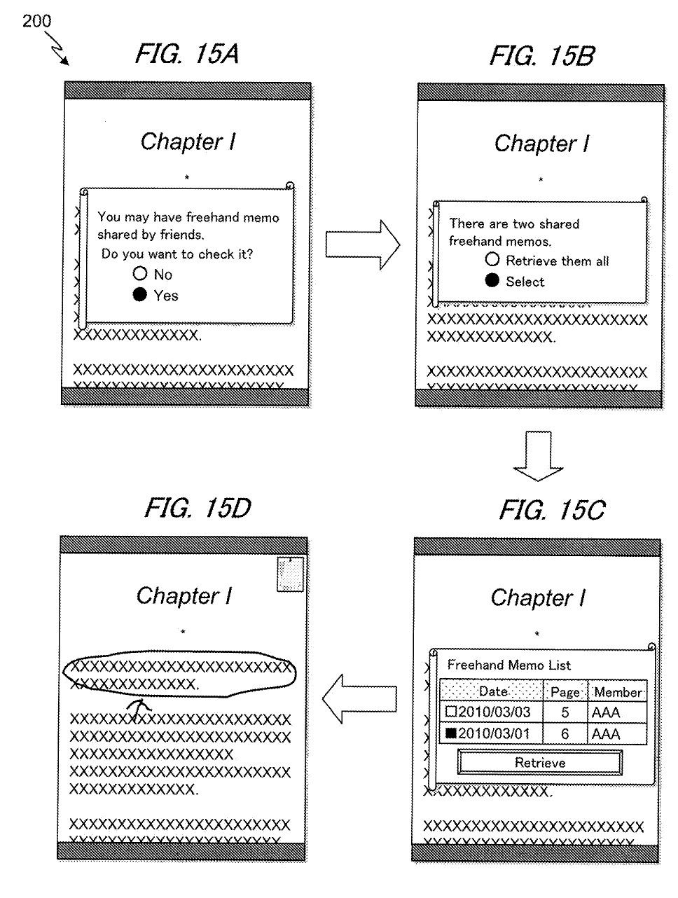

FIG. 15 is a diagram illustrating examples of a screen upon displaying the freehand memo 105 stored in the content server 100 on the viewer 21. When a search for the freehand memo 105 stored in the content server 100 and shared is made at the step S411 of FIG. 12, the viewer 21 displays a screen as illustrated in FIG. 15A for user confirmation. In this manner, when not requiring to browse the freehand memo 105, the user can omit a wasteful access to the content server 100.

Then, when the viewer 21 displays information about the list of freehand memos 105 at the step S413 of FIG. 12, the viewer 21 displays a confirmation screen as illustrated in FIG. 15B and a selection screen including the list of the freehand memos 105 as illustrated in FIG. 15C to let the user select a freehand memo 105 to be displayed. Then, the viewer 21 displays the selected freehand memo 105 at the step S417 of FIG. 12 as illustrated in FIG. 15D. Note that, as for a freehand memo 105 shared with other users, while one of the sharing users is updating the freehand memo 105, the comment browsing unit 132 of the content server 100 preferably performs exclusive control, such as displaying to the other users in a read-only mode.

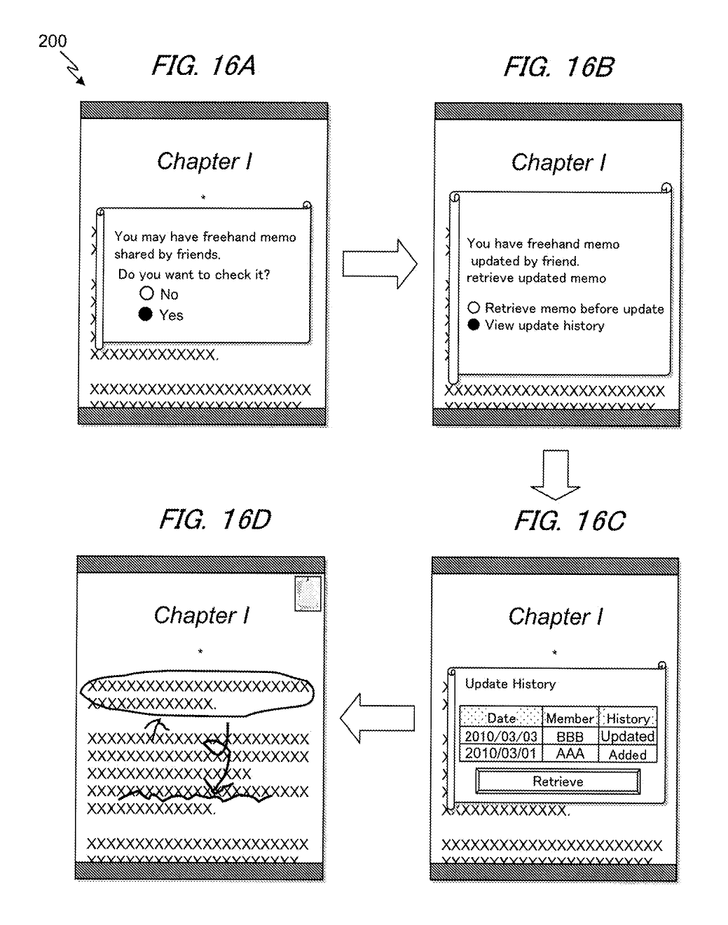

FIG. 16 is a diagram illustrating other examples of the screen upon displaying the freehand memo 105 stored in the content server 100 on the viewer 21. In the same manner as the case of FIG. 15, when searching for the freehand memo 105 stored in the content server 100 and shared at step the S411 of FIG. 12, the viewer 21 displays a screen as illustrated in FIG. 16A to the user for confirmation.

Here, when the freehand memo 105 added by the user himself or herself, stored in the content server 100, and shared with another user is updated by the other user, the viewer 21 displays a confirmation screen as illustrated in FIG. 16B and a confirmation screen including information of update history as illustrated in FIG. 16C. In this manner, whether to display the original freehand memo 105 before updating or the freehand memo 105 after updating by another user is selected. Then, the viewer 21 displays the selected freehand memo 105 as illustrated in FIG. 16D at the step S417 of FIG. 12.

Note that update history of the freehand memo 105 may be retained in the freehand memo DB 106 or may be added as a comment to the target content 101. Also, in the content server 100, when the freehand memo 105 is updated by another user, the file name of the freehand memo 105 after updating is named as “content ID+member ID+updating member ID+serial number” (such as “B0001_U0002_U0003_{—}001.gif”). In this manner, the freehand memo 105 before updating and the freehand memo 105 after updating (also including a plurality of times of updating by the same user) can be individually retained in association with each other.

[Processing Contents—Developed Functions]

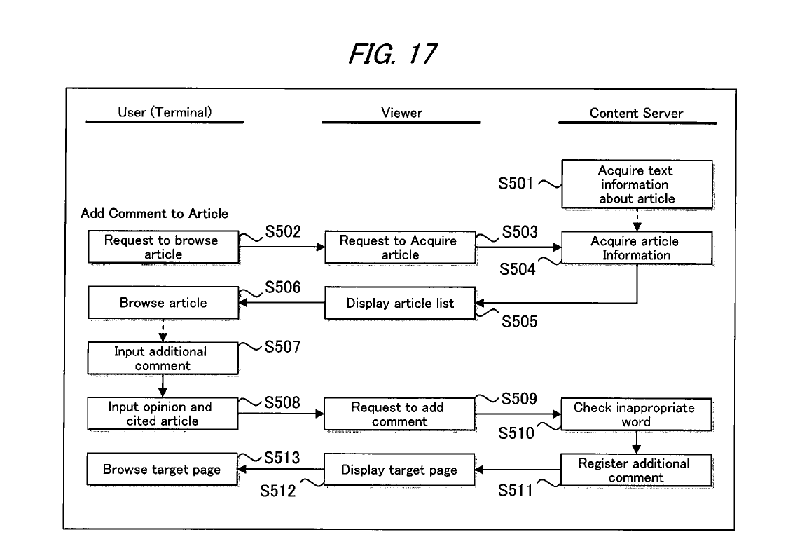

In the following, contents of processings for achieving various developed functions in the electronic book system 1 of the present embodiment will be described. FIG. 17 is a diagram illustrating an example of a process flow upon adding a comment to the content 101 (an electronic article) such as a newspaper article or news. First, when text information about these article contents of the content interface output circuit 101 can be obtained in advance, the content server 100 obtains and retains them as text information attached to the content 101 (S501). For example, when text information is attached to the content 101, this text information can be used. Also, by using various character recognition techniques, the electronic article may be converted to a text article to acquire the same.

The user uses the terminal 20 to make a request for viewing the article (content 101) (S502). The viewer 21 transmits a request for acquiring a list of contents 101 to the content server 100 (S503). In the content server 100, the reproduction processing unit 110 refers to the content DB 102, the member DB 103, and others to determine whether the user is allowed to browse the contents 101. When the user is allowed to browse, information about the list of the contents 101 is obtained and transmitted to the viewer 21 (S504). With the list of the contents 101 being browsed on the viewer 21 based on the transmitted contents (S505), the user can select and browse a target content 101 (S506).

Here, in the same manner as the steps S211 to S216 and the steps S221 to S228 of the comment adding processing illustrated in FIG. 9, the user can add a comment as text information to the content 101, its page, frame, and keyword. Here, when a comment is added for each content 101 (article) (S507), the user can set an opinion (stance) for the article and quote a previous article (S508). Through these steps, the user can conduct debates and exchange opinions full of substance. The processes at the steps S509 to S513 are similar to those at the steps S212 to S216 of FIG. 9, and therefore will not be described herein.

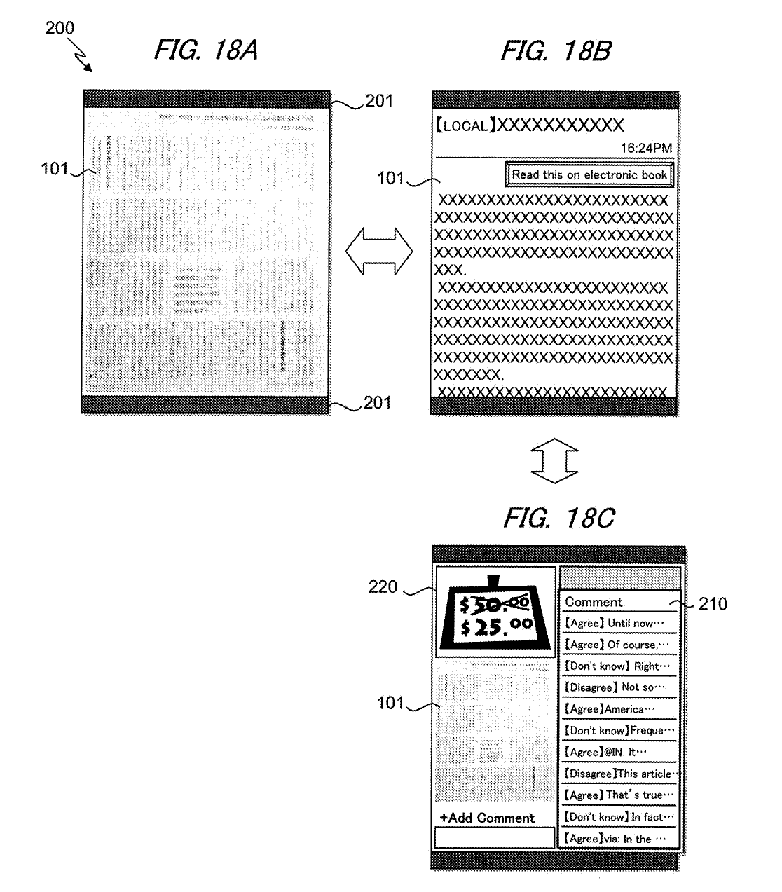

FIGS. 18A to 18C are diagrams illustrating examples of a screen upon displaying the content 101 of an electronic article and a comment on the viewer 21. FIG. 18A illustrates an example in the case where the viewer 21 displays a page of the content 101 of an electronic article. Here, for example, upon an instruction or the like from the user via the menu area 201, as illustrated in FIG. 18B, the viewer 21 displays the text information of the target content 101 obtained at the step S501 of FIG. 17 as a text article. A display in an electronic article form in FIG. 18A and a display in a text article form in FIG. 18B can be switched to each other as appropriate.

FIG. 18C is a diagram illustrating an example of the screen upon displaying a comment view for the article. In the example of FIG. 18C, in the same manner as the comment view illustrated in FIG. 8C, the content 101 (article) is displayed as being reduced, and a list of comments added from a plurality of users to the target article is displayed in a time series in the comment list area 210. Also, for example, in the advertisement display area 220, an advertisement 107 determined by the advertisement processing unit 140 of the content server 100 is displayed as a target advertisement for the user.

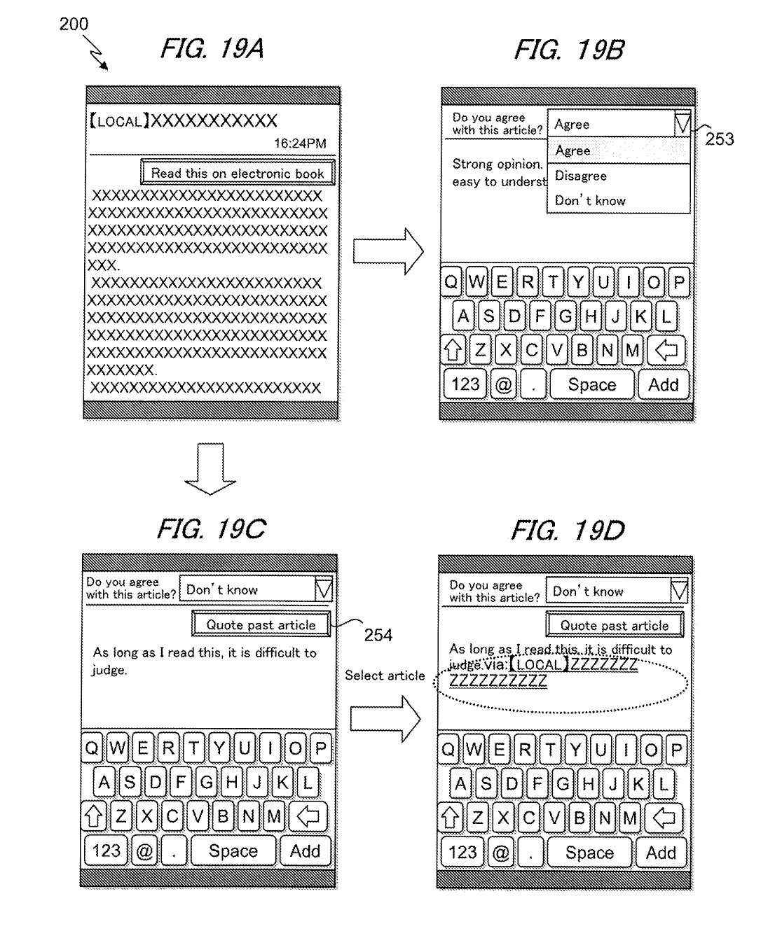

FIGS. 19A to 19D are diagrams illustrating examples of a screen upon adding a comment to the content 101 of an electronic article on the viewer 21. FIG. 19A illustrates an example of the case where, in the same manner as FIG. 18B, the target content 101 is displayed as a text article. Further, FIG. 19B illustrates an example of the case where an opinion is set and a comment is added to the content 101 at the steps S507 and S508 of FIG. 17. Here, in a screen for inputting an additional comment similar to that of FIG. 10B, an opinion setting portion 253 is further provided.

With this opinion setting portion 253, the user can set an opinion (stance) to the target content 101 (article). The set opinion may be retained in, for example, the comment DB 104 of the content server 100, or may be inserted in the comment itself in a form of “@opinion=agree” or the like and retained. In this manner, neutral feedbacks on the target article can be collected, and opinions can be shared and exchanged. Also, by compiling opinions from each user, marketing data useful for recommendation to the user and target advertisement can be obtained.

Note that, in the example of FIG. 19, an opinion is selected from “agree”, “disagree”, and “don't know”; however, classification of opinions is not restricted to this, and various options, such as “satisfied” and “dissatisfied”, can be set according to the contents of the article. This information can be set in advance in, for example, the content DB 102.

Further, FIG. 19C illustrates an example of the case where a previous article is quoted for the content 101 to add a comment at the steps S507 and S508 of FIG. 17. Here, in an additional-comment input screen similar to that of FIG. 19B, with the user pressing a previous article button 254, the viewer 21 displays a screen for displaying a list of articles not shown. Here, when the user selects an article to be quoted, as illustrated in FIG. 19D, a link to the selected article is inserted in the comment. In this manner, it is possible to conduct debates and exchange opinions full of substance being linked more to the topic of the article.

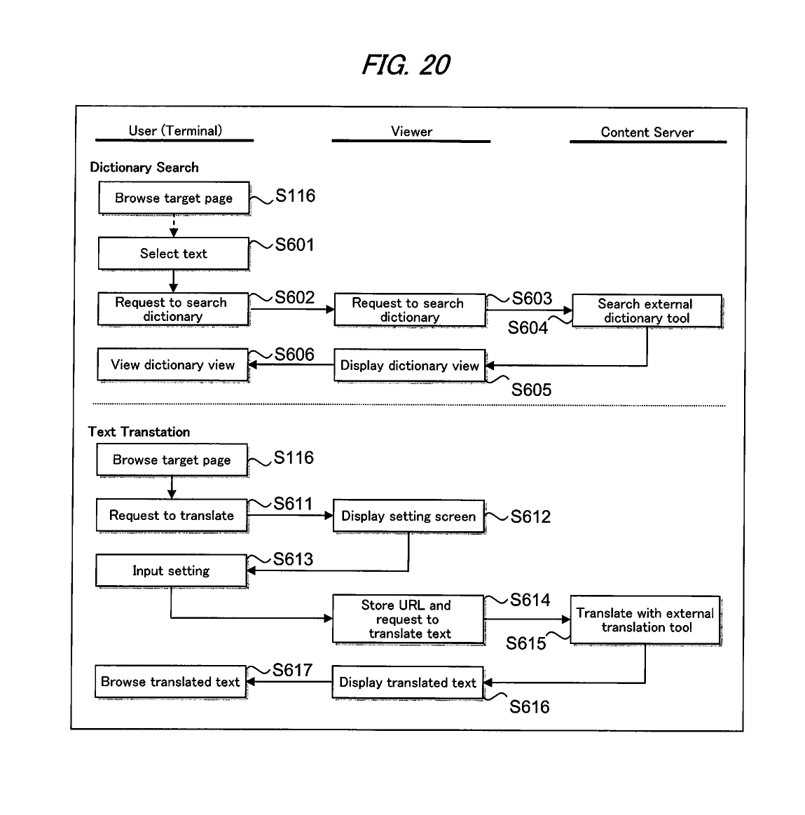

FIG. 20 is a diagram illustrating an example of a process flow upon searching a dictionary for a keyword of the content 101 and translating and browsing text information of the content 101. For example, when the target page is browsed on a screen as illustrated in FIG. 10C, the user selects a range to be specified as a keyword for a dictionary search in the text information within the page (S601), and makes a request for a dictionary search (S602). The viewer 21 transmits a request for a dictionary search including the selected keyword to the content server 100 (S603). In the content server 100, the dictionary search unit 151 uses the external dictionary tool 33 etc. to search for the keyword, and transmits information about the search result to the viewer 21 (S604). Having a dictionary view being displayed on the viewer 21 based on the transmitted contents (S605), the user can view the dictionary search result (S606).

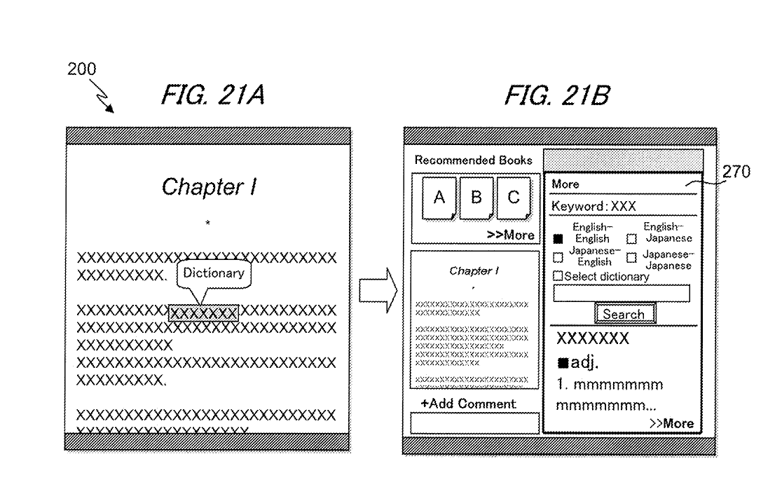

FIGS. 21A and 21B are diagrams illustrating examples of a screen at the time of searching a dictionary for a keyword of the content 101 on the viewer 21. FIG. 21A is a diagram illustrating an example of a screen when a range of a keyword for a dictionary search is specified at the step S601 of FIG. 20. Here, the specification can be made through an interface similar to that for specification of a keyword upon adding a comment to a keyword. As illustrated in the drawing, a range of a word to be specified as a keyword is selected with a procedure of, for example, a range specification in text editing, and a “dictionary search” popup is clicked, for example. In this manner, a word included in the specified range can be selected as a keyword for a dictionary search. In the same manner as the case of adding a comment, the selected keyword is specified with the number of bytes from the head of the content 101 or the page.

FIG. 21B is a diagram illustrating an example of a screen upon displaying a dictionary view for displaying the dictionary search result. Here, in a screen similar to that of the comment view as illustrated in FIG. 8C, a dictionary area 270 is displayed in place of the comment list area 210. In the dictionary area 270, in addition to browsing the dictionary search result, for example, operations can be performed, such as selecting a type of dictionary for use and displaying the dictionary area 270 in a full screen.

Referring back to FIG. 20, when browsing the content 101 on a screen as illustrated in FIG. 10C, the user can make a request for translating text information of the content 101 (S611). When the user requests translation, the viewer 21 displays a setting screen for setting translation (S612). When the user inputs a translation setting on the setting screen (S613), the viewer 21 stores a URL (Uniform Resource Locator) of a translation source (external translation tool 34) in the translation setting contents, and transmits a request for a text translation including information about the target content 101 and the translation setting contents to the content server 100 (S614).

In the content server 100, the translation unit 152 uses the external translation tool 34 etc. to translate the text information of the target content 101, and transmits the translated text information to the viewer 21 (S615). Having the translated text information being displayed on the viewer 21 based on the transmitted contents (S616), the user can browse the translated text information of the content 101 (S617).

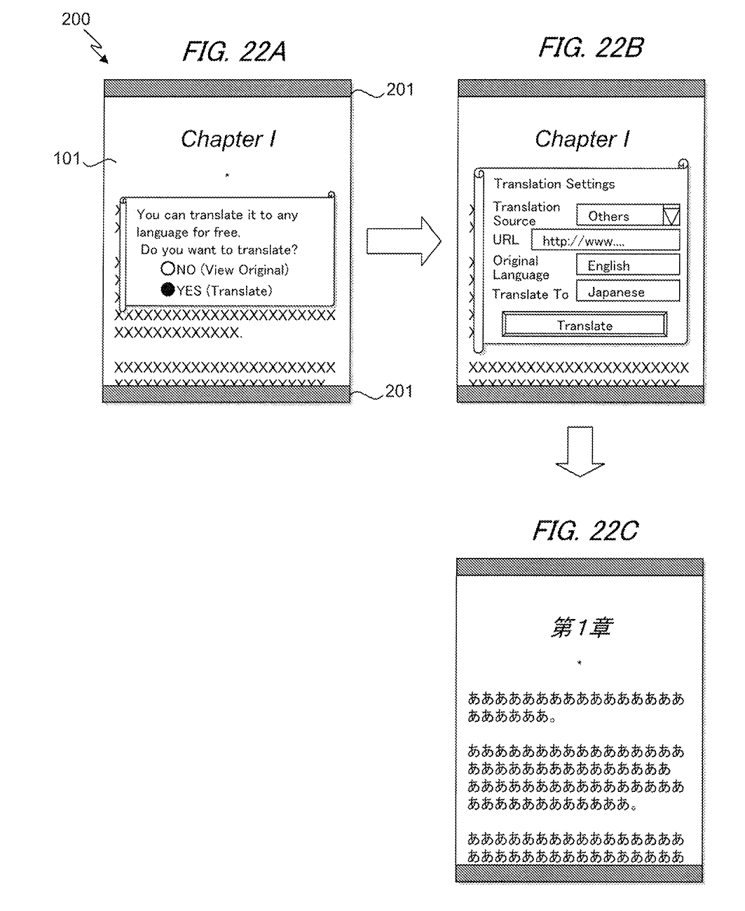

FIG. 22 is a diagram illustrating examples of a screen upon translating and browsing text information of the content 101 on the viewer 21. FIG. 22A illustrates an example of a screen when the user makes a request for translation of the content 101 at the step S611 of FIG. 21. When the content 101 includes text information, that text information can be translated.

Here, when execution of translation is selected, the viewer 21 displays a translation setting screen as illustrated in FIG. 22B. Here, as a translation source, the external translation tool 34 can be specified. Other than those defined in advance, a URL of a translation site can be directly specified. Note that, having this information being stored in the viewer 21 at the step S614 of FIG. 21, the information can be set as a default value even when translation is performed on another content interface output circuit 101 from the next time. Further, a translation language can be specified from among languages that can be used in translation.

When translation setting is performed to execute translation, translated text information is displayed as illustrated in FIG. 22C. When displaying the text information, the viewer 21 may read the translated text information for display, or the viewer 21 may reload the external translation tool 34 via the translation unit 152 of the content server 100 for display.

Note that, although the content 101 formed of text is to be translated in the example of FIG. 22, as for an image content (for example, a comic) with sentences described in balloons or note being inserted in the content 101 as text information, the text information portion can be translated by being handled in the same manner as the contents 101 formed of text. The same goes for addition of a comment to the keyword and a dictionary search described above. Note that, as for translation, for example, the translation unit 152 or the like re-encodes the translation result in the external translation tool 34 in an appropriate file format and takes it as translated content interface output circuit 101, thereby inserting the text information of the translation result at an appropriate position in an image of the content 101.

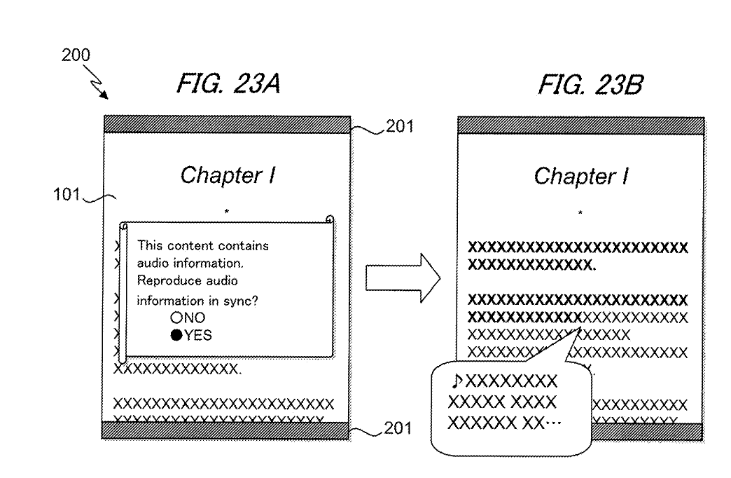

Furthermore, in the present embodiment, when audio information is attached to the content 101 and when the content 101 and audio information are managed in association with each other, the text information of the context 101 and the audio information are synchronously reproduced and displayed on the viewer 21. FIG. 23 is a diagram illustrating an example of a screen in the case of synchronous reproduction of audio information at the time of browsing the content 101 on the viewer 21. For example, when the content 101 on a screen as illustrated in FIG. 10C is browsed and text information and audio information can be synchronously reproduced for the target content 101, the viewer 21 can display a screen as illustrated in FIG. 23A to ask the user to confirm whether to perform synchronous reproduction.

When the user selects synchronous reproduction of the text information and the audio information, when reproducing the content 101 through streaming or the like, in the reproduction processing unit 110 of the content server 100, the audio synchronization unit 153 synchronously reproduces the text information of the content 101 and the audio information. Here, for example, as illustrated in FIG. 23B, the viewer 21 explicitly demonstrates a currently-reproduced position of the audio in the text of the content 101. As a synchronous reproduction technology in the content server 100, as described above, for example, any known technology for use in, for example, karaoke machines and language learning systems, can be used.

As described above, according to the electronic book system 1 according to the first embodiment of the present invention, text information and image information contained in an electronic book (content 101) and various information items provided to the electronic book (also including comments provided by users, meta information regarding the comments, update history information, and others) can be collectively managed by the content server 100, and sharing of some of these information items, if possible, is performed among a plurality of users, and contents of these information items are acquired and analyzed, for example, by the comment processing unit 130, the advertisement processing unit 140, the reproduction support unit 150, and others, thereby providing various services for further improving usability for the users.

That is, the user is allowed to add a comment of text information to the content 101 being browsed and also to share the comment with another user (other users). This comment can be not only added for each unit, such as the contents 101, page, or frame, but also added to text (a keyword). Here, for example, a comment for a specific user can be provided, and a comment can be posted to various SNS sites. Also, for example, when a comment is added to an article or news, by setting an opinion or quoting a previous article, the contents of the comment can be more clarified.

Further, by performing an analysis based on compilation (accumulation) of information regarding the comments added by the users, it is possible to recommend an optimum content 101 and display an advertisement for the user. Still further, it is also possible to add a freehand memo to the content 101 as a comment and also share the freehand memo with another user. Since text information items of the comment and freehand memo are managed separately from the content 101, the information items can be managed without depending on the platform of the terminal 20 for browsing the content 101, and can be displayed on the terminals 20 of different platforms.

Still further, by using the text information contained in the electronic book, it is possible to, for example, perform a dictionary search for a keyword, automatically translate the text for display, and perform synchronous reproduction with audio information.

### Second Embodiment

An electronic book system according to a second embodiment of the present invention is a system which uses and expands various functions for freehand memos in the electronic book system 1 of the first embodiment described above, and, not only allows the user to provide a freehand memo simply as a comment to the electronic book (content 101) but also allows the user to edit the contents (image) of the content 101 themselves and to share the edited electronic book (content) with another user (other users), thereby providing various services further attractive to the user. Note that the electronic book according to the present embodiment may not have text information in the content itself, for example, a photography book or a comic.

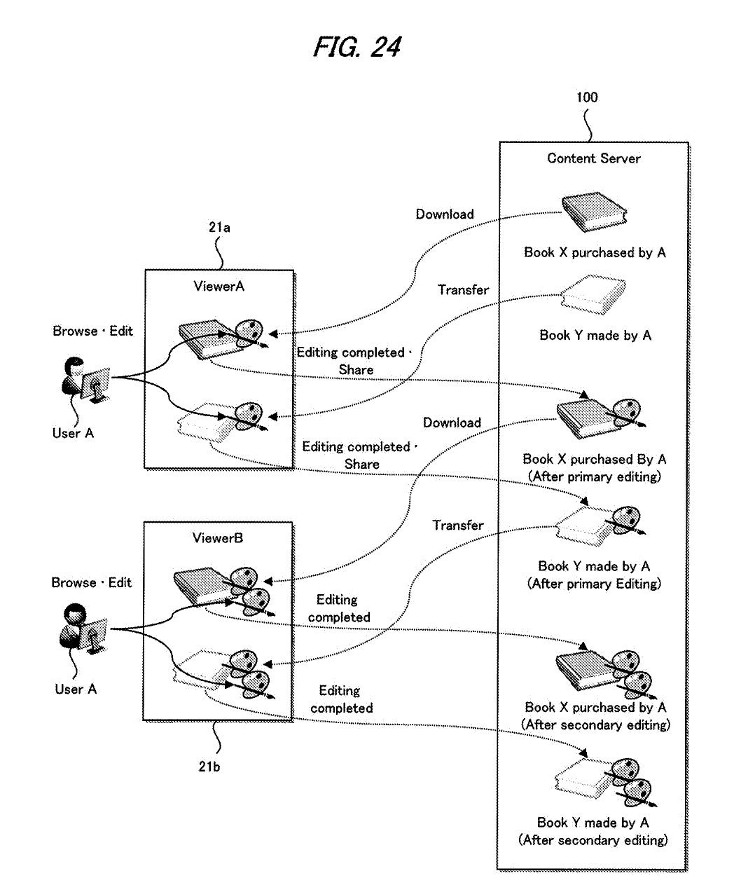

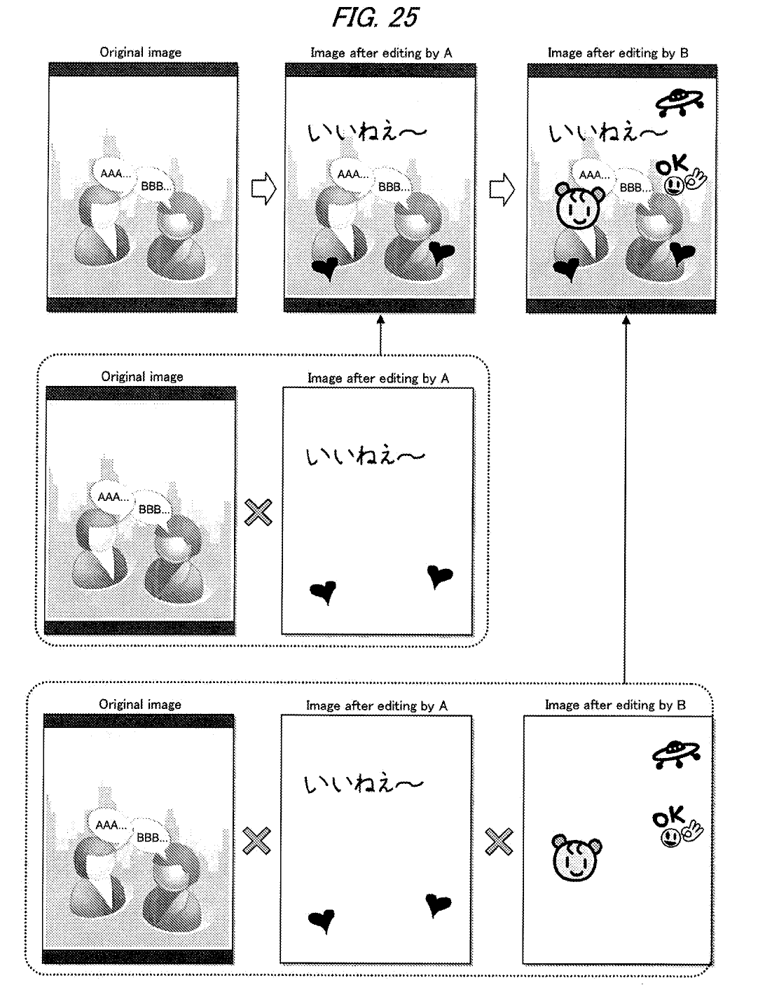

FIG. 24 is a diagram illustrating a general outline of an example of an image editing and sharing of an electronic book according to the present embodiment. For example, it is assumed that the content server 100 includes an electronic book X purchased by a user A and an electronic book Y made by the user A himself or herself by, for example, scanning an actual book or the like for conversion to an electronic book. In this case, the user A is allowed to download or transfer the electronic books X and Y to his or her own terminal 20 and edit them on a viewer A (21a).

When editing is completed, the user A sets that these books are allowed to be shared with another user (for example, a user B) (when the electronic books X and Y themselves are set to be shared or each of the users has purchased them), and uploads them to the content server 100 for storage. In this case, the uploaded electronic books X and Y are electronic books after primary editing by the user A.

Then, similarly, the user B allowed to share and access the electronic books X and Y can download or transfer the electronic books X and Y after primary editing to his or her own terminal 20, and additionally edit them on a viewer B (21b). When editing is completed, the user B uploads them to the content server 100 for storage. In this case, the uploaded electronic books X and Y are electronic books after secondary editing by the user B.

In this manner, by allowing a plurality of users to edit the contents of (image (s) in) the electronic book and share it, it is possible to provide a service not simply as means of communication but also allowing a new electronic book to be created.

FIG. 25 is a diagram illustrating a general outline of a configuration example of an edited content edited by a plurality of users. In an upper portion of FIG. 25, a state is illustrated from left to right such that the user A edits the original image on any page of the content 101 and the user B further edits the same.

In this case, as illustrated in a middle portion of FIG. 25, the image edited by the user A is configured by displaying layers which are overlaid, the layers retaining contents of editing the original image by the user A as an independent image data. Also, as illustrated in a lower portion of FIG. 25, the image edited by the user B is configured by displaying, in a superposed manner, the layers retaining contents of editing the original image by the user A and layers retaining contents of editing by the user B. By using such a configuration, as it will be described further below, only an edited portion (layer) by each user can be displayed or deleted, and the original image can be easily recovered.

Note that, when a function of displaying only an edited portion by each user by switching as it will be described further below is not required, editing by the users may not use layers, and may be in a form of directly editing an image for editing obtained by copying (duplicating) the original image.

[System Configuration]

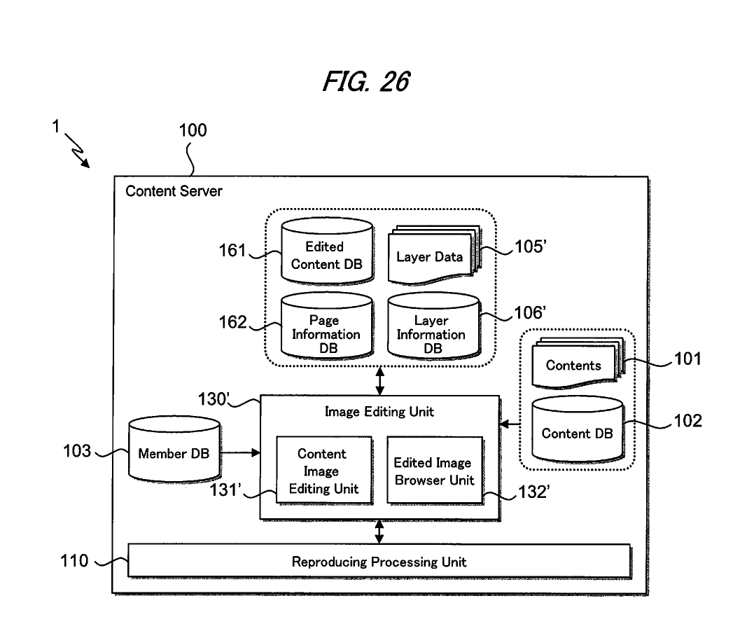

FIG. 26 is a diagram illustrating a general outline regarding a part of a configuration example of an electronic book system according to the second embodiment of the present invention. A basic configuration of an electronic book system 1 is similar to that of the electronic book system. 1 illustrated in FIG. 1 of the first embodiment. However, in the present embodiment, a content server 100 includes an image editing unit 130′ based on the comment processing unit 130, and layer data 105′ and layer information DB 106′ corresponding to the freehand memo 105 and the freehand memo DB 106. These components may be implemented by using and extending the comment processing unit 130, the freehand memo 105, and the freehand memo DB 106 in FIG. 1, respectively, or may be implemented as separate independent processing units of the comment processing unit 130, the freehand memo 105, and the freehand memo DB 106.

The image editing unit 130′ further includes a content image editing unit 131′ and an edited image browser unit 132′ based on the comment registration unit 131 and the comment browser unit 132 of the comment processing unit 130 in FIG. 1 of the first embodiment. Also, the content server 100 has databases or tables of an edited content DB 161 and a page information DB 162. Note that the other part of the configuration which has been illustrated in FIG. 1 of the first embodiment is not described herein.

The image editing unit 130′ has a function of editing the contents of (an image in) the content 101 by the content image editing unit 131′ and causing the edited content 101 to be displayed on the viewer 21 by the edited image browser unit 132′. “Editing” of the image herein means that this function is based on the function of adding a freehand memo in the first embodiment described above to which another editing function is added.

That is, on the viewer 21, a layer that can be displayed in a transparent format on a target page of the content 101, and the user can draw a character or an image freehand on that layer and also attach an existing image thereonto. In this manner, in the same manner as the freehand memo 105 in the first embodiment, each layer is retained as layer data 105′ formed of an image file independently retaining contents of editing the original image. Also, meta information regarding the layer data 105′ is retained in the layer information DB 106′.

As such, in the present embodiment, the layer data 105′ added to the content 101 is handled not only as a comment but also editing of the contents of (image(s) in) the content 101. Therefore, with user's editing, a new content (edited content) is created based on the content 101 (master). This edited content information is retained in the edited content DB 161.

Also, in the present embodiment, it is assumed that the editing function includes not only a process of editing the contents of (image(s) in) an existing page of the content 101 but also a process of adding or deleting a new page and moving a page. Information about these contents of page editing is retained in the page information DB 162 retaining information about each page of the edited content.

[Data Structure]

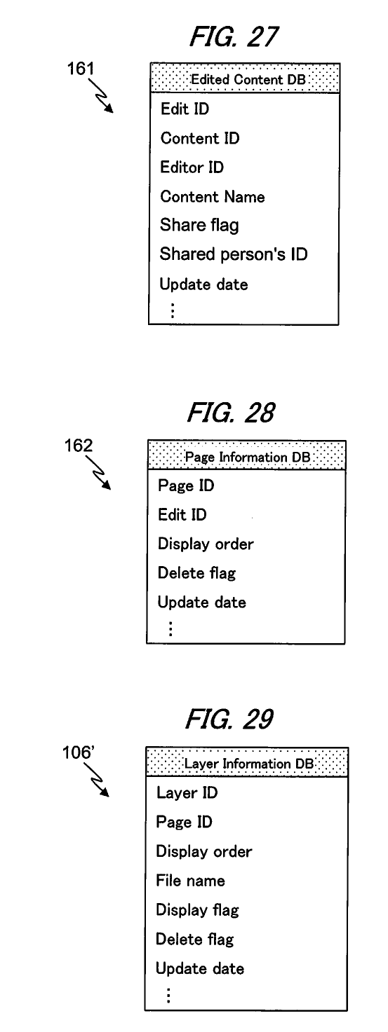

FIG. 27 is a diagram illustrating an example of a data configuration of the edited content DB 161. The edited content DB 161 is a table which manages various attribute information regarding an edited content newly created by the user editing the content 101, and has items including, for example, edit ID, content ID, editor ID, content name, share flag, shared person's ID and update date.

The edit ID item retains ID information uniquely identifying an edited content created from the content 101 as a master. This can be also handled as information about a version of the edited content. The content ID item retains information specifying the content 101 as a master of the target edited content. The editor ID item retains information about a member ID specifying the user who created the target edited content by editing. The content name item retains information about the title of the target edited content. As a default value, the content name of the content 101 to be a master is set.

The share flag item retains information about a flag indicating, when the content 101 as a master of the target edited content is allowed to be shared with another user, whether to share the target edited content with another user. Also, the shared person's ID item retains information about a member ID specifying a target user in sharing the target edited content. Note that information about a plurality of users can be retained as the target user, and information about a group formed of a plurality of users can also be retained. The update date item retains information about a timestamp at the time of updating the contents of the target entry item. Note that each of these items above regarding the edited content DB 161 is merely an example and, as a matter of course, relevant information may be managed with another data configuration.

FIG. 28 is a diagram illustrating an example of a data configuration of the page information DB 162. The page information DB 162 is a table which manages information regarding contents of editing (adding, deleting, and moving) on each page of the target edited content, and has items including, for example, page ID, edit ID, display order, delete flag, and update date.

The page ID item retains ID information uniquely identifying each page of the target edited content. The edit ID item retains ID information specifying an edited content as an edit target. The display order item retains information about a display order (page numbers) in the edited content of the target page. The delete flag item retains information about a flag indicating whether the target page has been deleted from the edited content by user's editing. The update date item retains information about a timestamp upon updating the contents of the target entry item. Note that each of these items mentioned above regarding the page information DB 162 is merely an example and, as a matter of course, relevant information may be managed with another data configuration.

FIG. 29 is a diagram illustrating an example of a data configuration of the layer information DB 106′. The layer information DB 106′ is a table which manages meta information regarding the layer where contents of editing the target page by the user are drawn, and has items including, for example, layer ID, page ID, display order, file name, display flag, delete flag, and update date. Note that, although the contents of editing are drawn in the layer and retained in the present embodiment, this DB functions as an edit information DB that manages meta information regarding the contents of editing in consideration of, for example, directly editing the image for editing obtained by copying (duplicating) the original image.

The layer ID item retains ID information uniquely identifying the target layer. The page ID item retains ID information specifying a page added with the target layer. The display order item retains information about a display order (an order from top or bottom when overlaying layers) in a page of the target layer. The file name item retains information about the file name of the file (layer data 105′) retaining image data of the layer. Note that, in the same manner as the freehand memo DB 106 illustrated in FIG. 5 of the first embodiment, the file name may be used as a layer ID.

The display flag item retains information about a flag indicating whether to display the target layer when the target page is browsed on the viewer 21. Also, the delete flag item retains information about a flag indicating whether the target layer has been deleted by the user's editing. The update date item retains information about a timestamp upon updating the contents of the target entry item. Note that each of these items above regarding the layer information DB 106′ is merely an example and, as a matter of course, relevant information may be managed with another data configuration.

Also, although the example has been exemplarily described above where sharing with another user is possible in the units of edited contents, whether to share with another user can be set in units of pages and/or layers.

[Process Details-Image Editing]

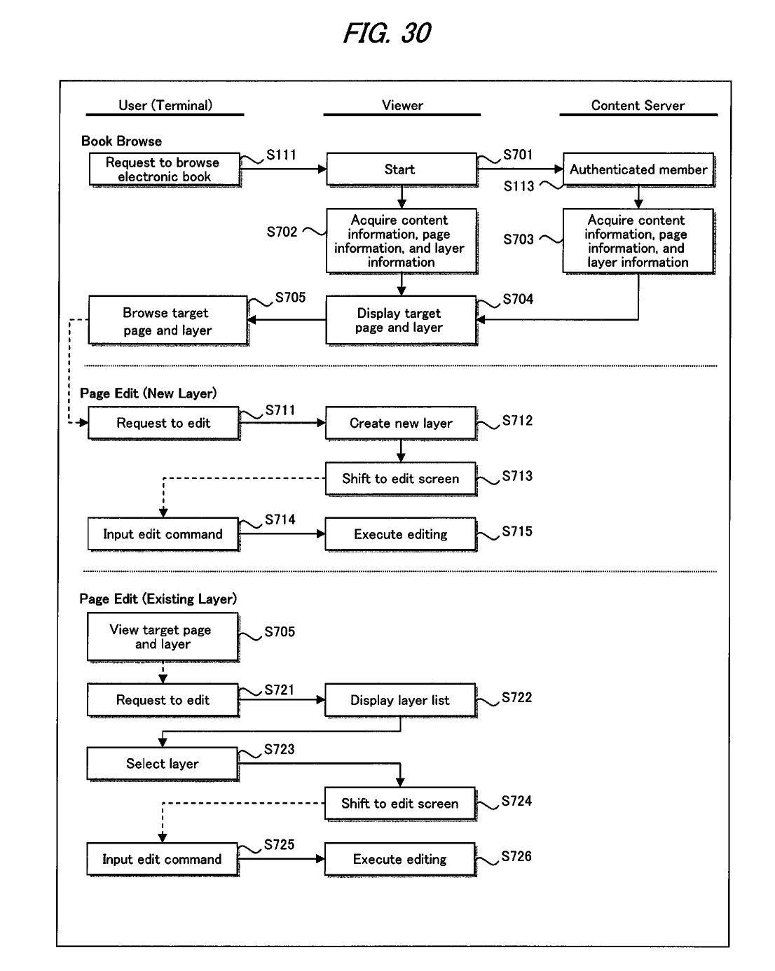

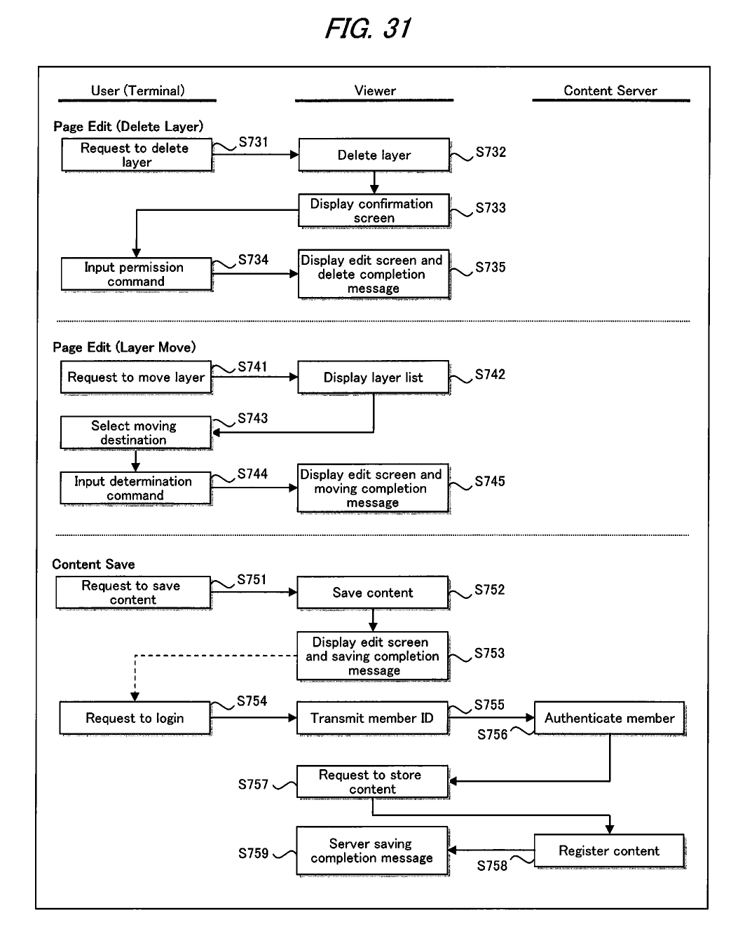

In the following, contents of processings for achieving an image editing function in the electronic book system 1 of the present embodiment will be described. FIGS. 30 and 31 are diagrams illustrating an example of a process flow upon editing a target page of the content 101. In FIG. 30, in the same manner as the step S111 of FIG. 7 of the first embodiment, the user using a service of editing an electronic book by the electronic book system 1 first makes a request for viewing an electronic book (content 101) by using the terminal 20 to select the electronic book from a menu or the like (S111).

According to the viewing request from the user, the terminal 20 starts the viewer 21 (S701). Here, in the same manner as the step S112 of FIG. 7 of the first embodiment, the user may input the member ID and authentication information to login the electronic book service provided by the content server 100 or may perform processings only on the local terminal 20 without logging in.

When login is not performed, regarding a content retained in advance on the local terminal 20 acquired by, for example, downloading from the content server 100 or creating it on the terminal 20 by the user, the viewer 21 acquires content data and information regarding pages and layers (S702), and displays a target page and a layer (contents of previous editing) added to the target page (S704). When the user logs in at the step S701, the viewer 21 transmits information about the member ID, authentication information, and a content to be viewed (content 101 or its edited content) to the content server 100. In the content server 100, in the same manner as the case of FIG. 7 of the first embodiment, the authenticating unit 120 refers to the member DB 103 for authentication to determine whether the user is a member (user authentication) (S113).

Then, the reproduction processing unit 110 refers to the content DB 102, the member DB 103, and others to determine whether the user is allowed to browse the target content 101. When the user is allowed to browse the target content 101, contents of the content (content 101 or its edited content) and the page are acquired. Furthermore, layer information is obtained via the edited image viewing unit 132′ and transmitted to the viewer 21 (S703). Here, what is referred to are the content DB 102, the member DB 103, the edited content DB 161, the page information DB 162, the layer information DB 106′, and others. Having the target page and layer being displayed on the viewer 21 based on the transmitted contents (S704), the user can browse the page and layer (contents of previous editing) of the target content (content 101 or its edited contents) (S705).

The user can edit the target page being viewed as needed. For example, when newly performing editing, the user makes a request for editing by using a menu, a command, or the like provided by the viewer 21 (S711). The viewer 21 receiving the edit request creates and displays a new layer on top or bottom of the target layer (S712), and moves to a screen for editing (S713). Note that the user may create a plurality of layers on the same page. The viewer 21 provides a layer ID that can uniquely identify each page for each layer.

In the editing screen of the viewer 21, the user inputs an edit command for editing the target layer as appropriate (S714). When an edit command is input, the viewer 21 reflects the contents of editing onto the target layer by executing the edit command (S715). Information about the target layer and the contents of editing (such as information about a page added with a layer and a display order etc.) is retained in the storage device of the local terminal 20 in a data configuration, for example, similar to that of the edited content DB 161, the page information DB 162, and the layer information DB 106′ illustrated in FIGS. 27 to 29.

As an edit command at the step S714, there are editing techniques, for example, drawing freehand as described in the first embodiment, character input using a software keyboard or the like, and insertion of a photo and image data and graphic data retained in the terminal 20. Also, for example, the type, thickness, color, and fill of a line when drawing and character input can be specified. Furthermore, for example, size change such as scaling and rotation of the drawn image and character, and zoom-in and zoom-out of the entire page can be specified.

Also, as described above, editing is performed in a manner such that the original image is retained and it is covered with a layer. Therefore, as it will be described further below, the editing contents can be cancelled and the original image can be easily restored, and a setting when browsing the layer can be switched between display and hide. For example, a setting can be made such that the layer is displayed on the viewer 21 only when the user who created and edited the layer is viewing.

Still further, an existing layer of the target page being viewed (contents of previous editing) can be edited as appropriate. For example, when editing an existing layer, the user makes an edit request by using a menu, a command, or the like provided by the viewer 21 (S721). When the viewer 21 receives the edit request, the viewer 21 acquires and displays a list of layers added to the target page (S722), and the user selects a target layer to be edited from the list (S723). The viewer 21 receiving information about the selected layer goes to a screen for editing the target layer (S724). The editing processes (S725 and S726) are similar to the editing processes at the steps S714 and S715 described above.

Also, the user can delete the target layer as an editing process with an edit command (cancel the contents of editing and return to the original). In FIG. 31, the user makes a request for deleting a layer as an edit command (S731). The viewer 21 receiving the delete request deletes the target layer (S732). Here, for example, in the data configuration corresponding to that of the layer information DB 106′ on the terminal 20, a delete flag is set for a record of the target layer.

Then, the viewer 21 displays a confirmation screen for confirming a deletion for the user (S733). On the confirmation screen, when the user performs a confirmation process (inputs a permission command) (S734), the viewer 21 displays a delete completion message and deletes a display of the target layer, and newly selects a layer on top or bottom to go to an edit screen (S735). Note that deletion can be cancelled (the deletion flag is returned to default) with an edit command, such as undo or redo.

Then, when the user completes an editing operation and ends the edit screen, for example, in the data configuration corresponding to that of the layer information DB 106′ on the terminal 20, deletion of a layer may be ensured by deleting the record of a layer set with a deletion flag. Also, in this case, when another layer is present on the target page, the value of the display order of the other layer is updated as required so that the other layer comes to the topmost with respect to the position of the deleted layer.

Similarly, the user can move the target layer (change the display order) as an editing processing according to an edit command. The user makes a request for moving a layer as an edit command (S741). The viewer 21 receiving the moving request acquires and displays a list of layers added to the target page (S742). When the user selects a layer to be moved and a position of a moving destination from the list (S743) and performs a determination processing (a determination command is input) (S744), the viewer 21 displays a movement completion message and also returns to the edit screen for the target layer (S745). Here, in the data configuration corresponding to that of the layer information DB 106′ on the terminal 20, the value of the display order of each layer is updated.

When the user ends the series of editing, restoring the edited content (electronic book) after editing is performed. For example, the user uses a menu and a command provided by the viewer 21 to make a request for storing the edited content (S751). Here, a target user or a group sharing the contents of the edited content can be specified. Also, when the edited content is shared with another user, whether to display a layer edited by the user himself or herself or another user can be set.

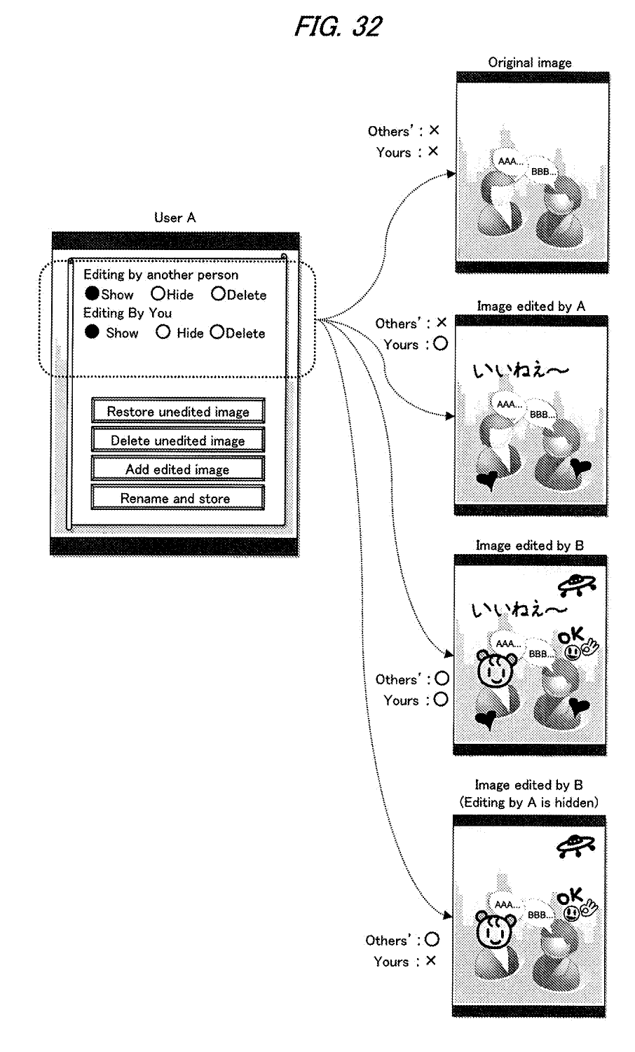

FIG. 32 is a diagram illustrating a general outline of an example of displays of contents of editing by each user when the edited content is shared. On the edit screen on the left in the drawing, a process menu is displayed. In this process menu, whether to display layers regarding contents of editing by another user (in the example of FIG. 32, the user B) and contents of editing by the user himself or herself (in the example of FIG. 32, the user A) can be set. Here, in the case where the editing has been performed by the user himself or herself (the user A) and another user (the user B) as illustrated in FIG. 25 described above, if the layers of both the user himself or herself (the user A) and another user (the user B) are set to be hidden, for example, the original image is displayed as illustrated on the right in the drawing when the user himself or herself (the user A) browses the edited content.

On the other hand, if the layer regarding the contents of editing by the user himself or herself (the user A) is set to be displayed, an image after editing by the user A is displayed. Also, if the layers of both the user himself or herself (the user A) and another user (the user B) are set to be displayed, an image after editing by the user B (after secondary editing) is displayed. Furthermore, if the layer regarding the contents of editing by another user (the user B) is set to be displayed, the image after editing by the user B with the contents of editing by the user himself or herself (the user A) hidden is displayed. Information about whether to display layers based on these settings can be retained as, for example, values of a display flag of the layer information DB 106′.

Referring back to FIG. 31, the viewer 21 receiving a store request at the step S751 first saves the edited content on the local terminal 20 (S752). Here, a record regarding the target edited content is added to the data configuration corresponding to the edited content DB 161 on the terminal 20. Then, a saving completion message is displayed, and the screen returns to the edit screen for the target edited content (S753).

Then, at an arbitrary timing when the user inputs the member ID and authentication information and makes a request for logging-in the electronic book service provided by the content server 100 for member authentication (S754 to S756), the viewer 21 transmits to the content server 100 data regarding the edited content stored on the local terminal 20 and meta information retained in the data configuration corresponding to the edited content DB 161, the page information DB 162, and the layer information DB 106′, and makes a request for storing (S757). For example, when a content, such as an electronic book, made by the user himself or herself and the content itself is not registered in the content server 100, the content itself is also transmitted.

In the content server 100, the content image editing unit 131′ of the image editing unit 130′ registers information regarding the edited content in the layer data 105′, the layer information DB 106′, the edited content DB 161, the page information DB 162, and others (S758). When registration is completed, a saving completion message is displayed on the viewer 21 (S759).

Note that, in the processing example described above, the information about the contents of editing on the local terminal 20 is retained offline without logging-in to the electronic book service (the content server 100), and the information of the contents of editing is transmitted and registered upon logging-in to the content server 100. Alternatively, as a matter of course, the configuration may be such that editing is performed in a state of logged-in to the electronic book service (the content server 100) and the contents of editing are registered online in the content server 100 as needed.

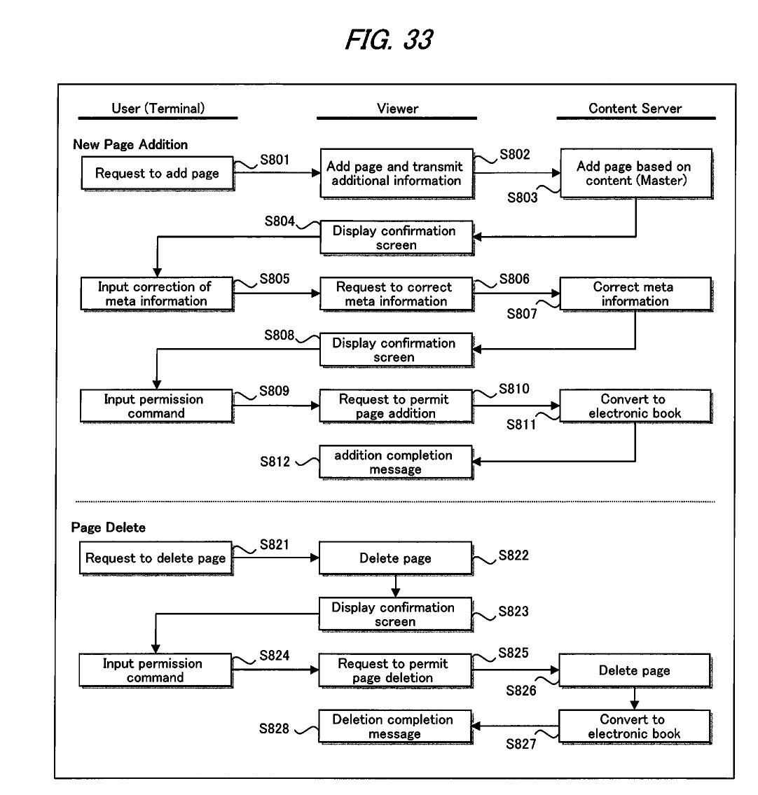

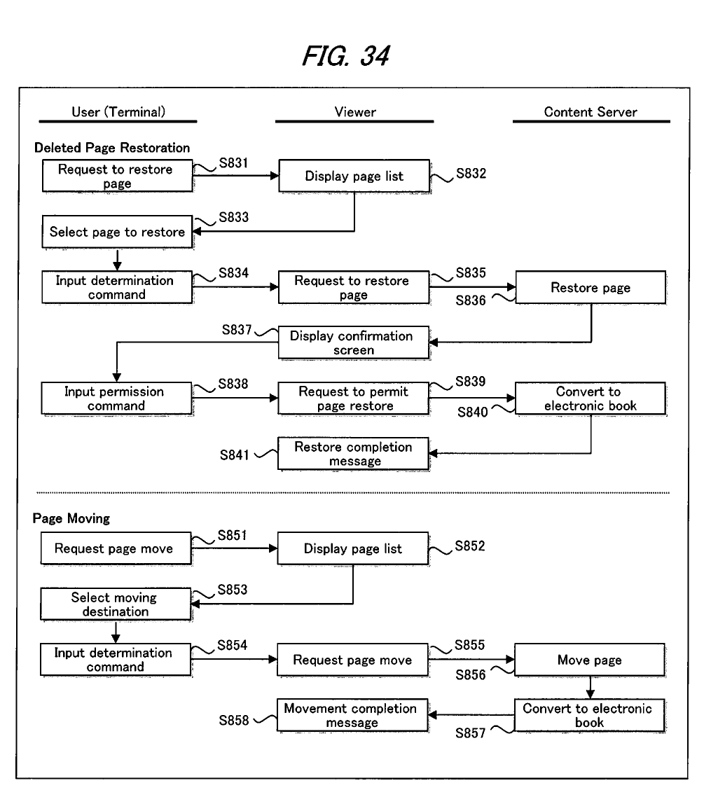

FIGS. 33 and 34 are diagrams illustrating an example of a process flow when editing the content 101 by adding or deleting a page. In FIG. 33, for example, when a new page is added to the target content 101, the user uses a menu, a command, or the like provided by the viewer 21 to make a request for adding a page (S801). The viewer 21 receiving a page adding request adds a new page before or after the current page on display, further adds one layer to the added page, and then transmits these pieces of information to the content server 100 (S802). That is, when editing by adding or deleting a page is performed, the user is required to be logged-in (or to log-in) to the electronic book service (the content server 100).

In the content server 100, the content image editing unit 131′ of the image editing unit 130′ specifies the edited content and information about the added page based on the content DB 102 and the information about the content 101 (the master content), stores the information in the edited content DB 161, the page information DB 162, the layer information DB 106′, and others, and then responds to the viewer 21 (S803). The viewer 21 displays a confirmation screen for page addition to the user (S804).

Here, when an edited content is newly created by adding a page, the user can correct or change the meta information, such as the title name and author name of the edited content, as required, based on the information of the master content 101 (S805). The viewer 21 receiving an input of correction and change of the meta information transmits the information to the content server 100 (S806). In the content server 100, based on the information from the viewer 21, the content image editing unit 131′ updates the contents of the target edited content in the edited content DB 161, and then responds to the viewer 21 (S807). In the same manner as the step S804, the viewer 21 displays a confirmation screen for page addition to the user (S808).

When the user performs a confirmation for page addition (inputs a permission command) (S809), the viewer 21 transmits a request for permitting page addition to the content server 100 (S810). In the content server 100, for example, the image editing unit 130′ converts (publishes) the target edited content to an electronic book, registers it as a content 101 in the content DB 102, and then responds to the viewer 21 (S811). The viewer 21 displays a page addition completion message (S812). At this time, a transition may be made to an editing screen for the added page.

Also, when the user deletes a page from the target content 101, the user uses a menu, a command, or the like provided by the viewer 21 to make a request for deleting a page (S821). The viewer 21 receiving a page deletion request deletes the target page and a layer added to the target page on display (S822), and displays a delete confirmation screen (S823). Here, in the same manner as the steps S805 to S807 described above, the meta information of the edited content can be corrected and changed.

When the user performs a confirmation processing for page deletion (inputs a permission command) (S824), the viewer 21 transmits a request for permitting page deletion to the content server 100 (S825). In the content server 100, for example, the image editing unit 130′ deletes the page by setting a deletion flag for the record of the relevant page in the page information DB 162 (S826). Upon browsing, the page set with the deletion flag is not displayed by the viewer 21 but is skipped. Thus, from the user, the page can look as if it has been deleted. Note that, in the case of a content (electronic book) not purchased but made by the user himself or herself, stores of the target page and a layer added thereto may be deleted from the page information DB 162 and the layer information DB 106′.

Then, the content server 100 converts (publishes) the target edited content to an electronic book, registers it as a content 101 in the content DB 102, and then responds to the viewer 21 (S827). The viewer 21 displays a page deletion completion message (S828).

Even when a page is deleted by the processing above, regarding the purchased content (electronic book), for example, all of the original page information before editing remains in the master content 101, and therefore the deleted page can be restored. In FIG. 34, the user uses a menu, a command, or the like provided by the viewer 21 to make a page restore request (S831). The viewer 21 receiving the page restore request acquires and displays information about a list of pages of the target content (S832). Here, information about the master page of the target content may be used, and alternatively, by making an inquiry of the content server 100, information about a page where a delete flag is set in the page information DB 162 may be acquired and used.

When the user selects a target page to be restored from the list of pages (S833) and performs a determination process (inputs a determination command) (S834), the viewer 21 transmits a request for restoring the target page to the content server 100 (S835). In the content server 100, for example, the content image editing unit 131′ turns OFF the deletion flag of the record of the target page in the page information DB 162 to restore the page, and then responds to the viewer 21 (S836). The viewer 21 displays a confirmation screen for page restore to the user (S837). Here, in the same manner as the steps S805 to S807 describe above, the meta information of the edited content can be corrected and changed.

When the user performs a confirmation for page restore (inputs a permission command) (S838), the viewer 21 transmits a request for permitting page restore to the content server (S839). The content server 100 converts (publishes) the target edited content to an electronic book, registers it as a content 101 in the content DB 102, and then responds to the viewer 21 (S840). The viewer 21 displays a page restore completion message (S841).

Also, the user can also move the target page in the edited content (can change the display order). To move the target page, the user uses a menu, a command, or the like provided by the viewer 21 to make a request for moving a page (S851). The viewer 21 receiving the page moving request obtains and displays a list of pages of the target content (S852). Here, information about the target content retained on the local terminal 20 may be used, and alternatively, by making an inquiry of the content server 100, information may be obtained from the page information DB 162 and used.

The user selects a target page to be moved and a position of the moving destination from the list of pages (S853) and performs a determination processing (inputs a determination command) (S854), and the viewer 21 then transmits a request for moving the target page to the content server 100 (S855). In the content server 100, for example, the content image editing unit 131′ updates the display order of the target page in the page information DB 162 to a display order of the position of the moving destination, and further updates the subsequent display order of the other pages influenced by the movement by shifting, thereby moving the page (S856); and the content server 100 converts (publishes) the target edited content to an electronic book, and then responds to the viewer 21 (S857). The viewer 21 displays a page movement completion message (S858).

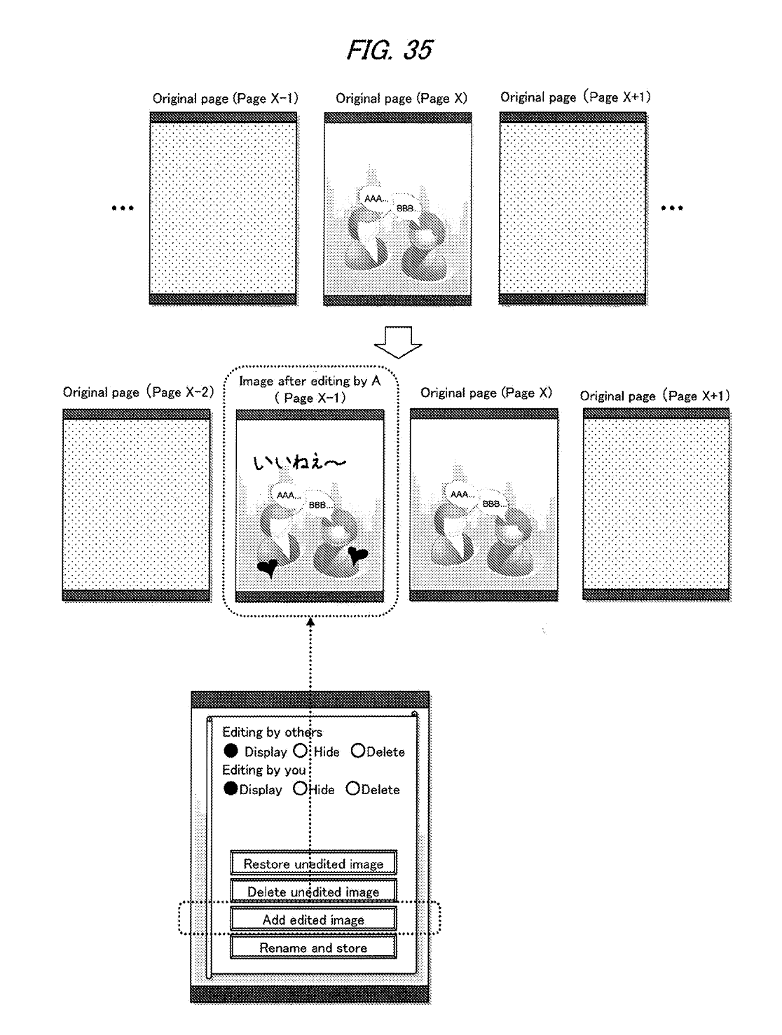

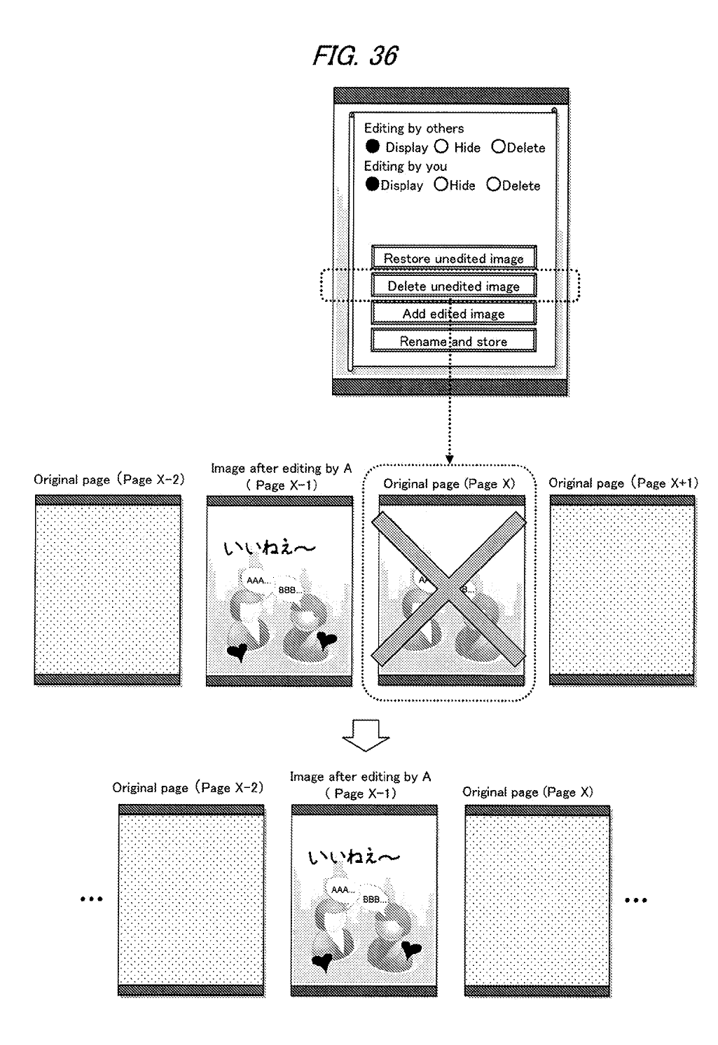

FIG. 35 is a diagram illustrating a general outline of an example of displays upon editing the content 101 by adding a page, and FIG. 36 is a diagram illustrating a general outline of an example of displays upon editing the content 101 by deleting a page. In FIG. 35, pages of the master content 101 (a page X−1, a page X, and a page X+1) are illustrated in an upper portion of the drawing so as to be arranged from left to right. By contrast, by using an edit screen illustrated in a lower portion of the drawing, a page (a page X−1) newly edited by the user A is added before the page X, which is exemplarily illustrated in a middle portion of the drawing.

Also, in FIG. 36, an arrangement, in which a page is newly added in the example of FIG. 35, is illustrated in a middle portion of the drawing. By contrast, by using an edit screen illustrated in an upper portion of the drawing, an image (the page X) in the master content 101 is deleted, which is exemplarily illustrated in a lower portion of the drawing. In the series of examples of FIG. 35 and FIG. 36, an editing form is illustrated such that the original image (the page X) in the master content 101 is replaced by an image (the page X−1) edited by the user A. Other than this, as a matter of course, editing of newly inserting a page with a totally new image and editing of simply deleting an unnecessary page are available.

As described in the foregoing, according to the electronic book system 1 according to the second embodiment of the present invention, by using and extending various functions regarding a freehand memo in the electronic book system 1 of the first embodiment, the user can not only provide a freehand memo simply as a comment to the electronic book (the content 101) but also can edit the contents of (an image in) the content 101 and allow the edited electronic book (content) to be shared with another user, thereby further providing various services more attractive to the users.

Also, when the contents of (an image in) the content 101 are edited, as editing information for the master content 101, editing information regarding a page and a layer is managed as the edited content DB 161, the page information DB 162, the layer information DB 106′, and others separately from the content 101. In this manner, not only editing by simply drawing or the like on an existing page but also editing by adding, deleting, and moving in units of pages from the user's point of view while having the master content 101 remain can be performed. In this manner, a service of creating a new electronic book and allowing it to be shared with another user (other users) can be provided.

In the foregoing, the invention made by the inventor of the present invention has been concretely described based on the embodiments; however, it is needless to say that the present invention is not limited to the foregoing embodiments and various modifications and alterations can be made within the scope of the present invention.

In the foregoing, the invention made by the inventor of the present invention has been concretely described based on the embodiments; however, it is needless to say that the present invention is not limited to the foregoing embodiments and various modifications and alterations can be made within the scope of the present invention.

The present invention can be utilized in an electronic book system and a content server providing various services, such as information sharing, by using various information items regarding an electronic book.

What is claimed is:

1. An electronic book system comprising: a content server that retains and manages a content containing an electronic book and provides a service regarding browsing of the content including the electronic book via a network; and a terminal having one or more viewers to be connected to the content server via the network for browsing the electronic book, wherein
the viewer includes: comment input means that receives an input of a comment to be added to a desired position of the electronic book from a user and transmits information including the comment and the position to which the comment is added to the content server; and freehand memo input means that receives an input of a freehand memo to be added to a desired position of the electronic book from the user and transmits information including the freehand memo and the position to which the freehand memo is added to the content server,
the content server includes a comment processing unit that retains information about the comment transmitted from the viewer in comment storing means in association with information about the user and the position to which the comment is added; retains information about the freehand memo transmitted from the viewer in freehand-memo storing means in association with the information about the user and the position to which the freehand memo is added in addition to storing information about an update history; when the user browses the electronic book using the viewer, acquires the information about the comment to a position in the electronic book being browsed added by each user from the comment storing means and causes the acquired information to be displayed on the viewer; also acquires the information about the freehand memo added to the position in the electronic book being browsed by the user from the freehand-memo storing means and causes the acquired information to be displayed on the viewer; and, when another user specified by the user browses the electronic book using the viewer, at a corresponding position in the electronic book, acquires the freehand memo retained in the freehand-memo storing means from the freehand-memo storing means and causes the acquired freehand memo to be displayed on the viewer of the another user.

2. The electronic book system according to claim 1, wherein,
when the information about the freehand memo added to the position of the electronic book being browsed by the user or another user is acquired from the freehand memo storing means to display the freehand memo on the viewer, the comment processing unit of the content server causes information about a list of the freehand memos which can be referred to by the user to be displayed on the viewer of the user, and causes the freehand memo selected by the user from the list to be displayed on the viewer of the user.

3. The electronic book system according to claim 1, wherein,
when a first freehand memo added by the user and stored in the freehand memo storing means is updated by another user as a second freehand memo,
the viewer lets the user select either one of the first freehand memo added by the user and the second freehand memo obtained by updating by the another user when displaying the freehand memo that can be referred to by the user.

4. The electronic book system according to claim 1, wherein
the comment input means of the viewer receives a specification of a character range in text information included in the electronic book from the user, and takes the character range as the position to which the comment is added, and
the comment processing unit of the content server retains the information about the comment transmitted from the viewer in the comment storing means in association with the information about the user and the character range regarding the comment-added position, and, when the user browses the electronic book by using the viewer, the comment processing unit causes a display to indicate that the comment has been added to the character range in the electronic book being browsed.

5. The electronic book system according to claim 1, wherein
the comment input means of the viewer receives an input of a target user adding the comment from the user and transmits information about the comment, the position to which the comment is added, and the target user to the content server, and,
when the user browses the electronic book using the viewer, the comment processing unit of the content server acquires information about the comment added to a position in the electronic book being browsed from the comment storing means and causes the acquired information to be displayed on the viewer for the user himself or herself.

6. The electronic book system according to claim 1, wherein
the content server can access an external comment posting system in accordance with an instruction from the user via the terminal, and the comment processing unit posts a comment added by the user using the viewer also to the comment posting system.

7. The electronic book system according to claim 1, wherein
the comment input means of the viewer receives an input of an opinion from the user to the target electronic book to which the comment is to be added, and transmits information items including the comment, the position to which the comment is added, and the opinion to the content server, and
the comment processing unit of the content server combines the information item about the comment and the information item about the opinion transmitted from the viewer and retains the combined information items in the comment storing means in association with the information items about the user and the position to which the comment is added.

8. The electronic book system according to claim 1, wherein,
when the comment is input by the user to the desired position of the electronic book, the comment input means of the viewer can insert a hyperlink to a previously distributed article in another electronic book in the comment.

9. The electronic book system according to claim 1, wherein
the content server further includes an advertisement processing unit that, when the comment processing unit causes the electronic book and the comment to be displayed on the viewer, determines information about an advertisement and/or another electronic book to be recommended to be displayed on the viewer at a predetermined display position of the electronic book based on information items including at least one of text information of the electronic book, the information about the comment added to the electronic book, and information about the user browsing the electronic book; and, when the user browses the electronic book using the viewer, the content server causes the determined information about the advertisement and/or the another electronic book to be recommended to be displayed on the viewer at the display position of the electronic book.

10. The electronic book system according to claim 1, wherein
the viewer further includes dictionary search requesting means that receives a specification of the character range in the text information included in the electronic book from the user and transmits a request for a dictionary search taking the character range as a search keyword to the content server, and
the content server further includes a dictionary search unit that performs a search with a dictionary tool based on the search keyword transmitted from the viewer and causes a search result to be displayed on the viewer.

11. The electronic book system according to claim 1, wherein
the viewer further includes translation requesting means that transmits a request from the user for translation of the text information included in the electronic book to the content server, and
the content server further includes a translation unit that translates the text information included in the electronic book by a translation tool based on the request for translation transmitted from the viewer and causes text information of a translation result to be displayed on the viewer.

12. The electronic book system according to claim 1, wherein
the viewer further includes audio reproduction requesting means that transmits a request from the user for reproducing audio information included in the electronic book to the content server, and
the content server further includes an audio synchronization unit that synchronously reproduces the text information and the audio information included in the electronic book on the viewer based on the request for reproduction transmitted from the viewer.

13. The electronic book system according to claim 1, wherein
the viewer further includes freehand memo input means that receives an input of a freehand memo to be added to a desired position of the electronic book from the user and stores information including the freehand memo and the position to which the freehand memo is added in the terminal.

14. A content server retaining and managing a content that includes an electronic book and providing a service regarding browsing of the content that includes the electronic book via a network, the content server comprising a comment processing unit, wherein
the comment processing unit receives information input from a user about a comment to be added to a desired position of the electronic book from a viewer for viewing the electronic book disposed in a terminal to be connected to the content server via the network, and retains the received information in comment storing means in association with information items about the user and the position to which the comment is added; receives information about a freehand memo to be added to a desired position of the electronic book input by the user from the viewer, retains the received information in freehand memo storing means in association with information about the user and the position to which the freehand memo is added, and also stores information about update history;
when the user browses the electronic book using the viewer, the comment processing unit acquires the information about the comment added by each user to a position in the electronic book being browsed from the comment storing means and causes the acquired information to be displayed on the viewer and also acquires the information about the freehand memo added by the user to the position in the electronic book being browsed from the freehand-memo storing means and causes the obtained information to be displayed on the viewer; and, when another user specified by the user browses the electronic book using the viewer at a corresponding position in the electronic book, the comment processing unit acquires the freehand memo retained in the freehand-memo storing means from the freehand-memo storing means and causes the acquired freehand memo to be displayed on the viewer of the another user.

15. An electronic book system comprising: a content server that retains and manages a content including an electronic book and provides a service regarding browsing of the content including the electronic book via a network; and a terminal including one or more viewers to be connected to the content server via the network for browsing the electronic book, wherein
the viewer includes editing means that receives an input of contents of editing an image on a desired page of the electronic book from a user owning the electronic book and transmits information including information items of the contents of editing and a target page to be edited to the content server,
the content server includes an image editing unit that retains information regarding the contents of editing transmitted from the viewer in edit information storing means in association with the information about the target page; retains information about an edited electronic book acquired by editing the electronic book by each user and information about each page regarding the edited electronic book in each of edited content storing means and page information storing means; and, when the user or another user allowed to browse the edited electronic book browses the target page of the edited electronic book with the viewer, causes the contents of editing the target page to be displayed, and
the contents of editing are newly retained in the edit information storing means when the another user inputs new contents of editing to the target page of the edited electronic book.

16. The electronic book system according to claim 15, wherein
the editing means of the viewer receives an input of contents of editing an image in a desired page of the electronic book from the user owning the electronic book, retains the contents of editing in a layer as image data independent of an original image of the target page, and transmits information items including the layer and the target page to which the layer is to be added to the content server,
the image editing unit of the content server retains the information about the layer transmitted from the viewer in the edit information storing means in association with the information about the target page, and, when the user or another user allowed to browse the edited electronic book browses the target page of the edited electronic book with the viewer, causes the layer added to the target page to be overlaid on the original image of the target page for display according to a display order stored in the edit information storing means, and
the contents of editing in another new layer are retained when new contents of editing are input by the another user to the target page of the edited electronic book.

17. The electronic book system according to claim 16, wherein,
when the user browses the target page of the edited electronic book with the viewer, based on an instruction from the user, the viewer switches between displaying and hiding contents added by the user and contents added by another user, for each layer added to the page of the edited electronic book.

18. The electronic book system according to claim 15, wherein
the editing means of the viewer receives a request for adding, deleting, or moving a page with respect to the electronic book or the edited electronic book from the user or the another user and transmits information items including information about a page that is added, deleted, or moved to the content server, and,
to the page information storing means, the image editing unit of the content server adds the information about the added page, stores deletion for a record of the deleted page, and updates the display order of the pages along with the page addition, deletion, or moving.

19. The electronic book system according to claim 15, wherein,
based on an instruction from the user who edited the edited electronic book, the contents of editing of the edited electronic book are returned to original by restoring contents of the edited content storing means, the page information storing means, or the layer information storing means.

20. A content server which retains and manages a content including an electronic book and provides a service regarding browsing of the content including the electronic book via a network, the content server comprising an image editing unit, wherein
the image editing unit receives, from a viewer arranged in a terminal to be connected to the content server via the network for browsing the electronic book, information about a layer retaining contents of editing a desired page of the electronic book input by the user owning the electronic book as image data independent of an original image of a target page and information about the target page to which the layer is to be added; retains the information about the layer in layer information storing means in association with the information about the target page; retains information about an edited electronic book obtained by editing the electronic book by each user and information about each page of the edited electronic book in each of edited content storing means and page information storing means; and, when the user or another user allowed to browse the edited electronic book browses the target page of the edited electronic book with the viewer, causes each of the layers added to the target page to be overlaid on the original image of the target page for display according to a display order stored in the layer information storing means, and
the contents of editing in another new layer is retained when new contents of editing are input by the another user to the target page of the edited electronic book.
